(19) United States
(12) Patent Application Publication
(10) Pub. No.: US 2025/0180088 A1
(43) Pub. Date: Jun. 5, 2025

(54) DAMPER DEVICE

(71) Applicant: PIOLAX, INC., Kanagawa (JP)

(72) Inventor: Kouichi KATO, Kanagawa (JP)

(73) Assignee: PIOLAX, INC., Kanagawa (JP)

(21) Appl. No.: 18/846,090

(22) PCT Filed: Jan. 31, 2023
(86) PCT No.: PCT/JP2023/003060

§ 371 Date: Sep. 11, 2024

(30) Foreign Application Priority Data
Mar. 24, 2022 (JP) 2022-048019

(51) Int. Cl. F16F 9/02; F16F 9/32; F16F 9/36; F16F 9/516

(52) U.S. Cl. CPC F16F 9/0218; F16F 9/0227; F16F 9/0281; F16F 9/3214; F16F 9/3221; F16F 9/3235; F16F 9/362; F16F 9/516; F16F 2222/126; F16F 2228/066; F16F 2230/0052; F16F 2230/30; F16F 2230/36; F16F 2234/02

(57) ABSTRACT

Provided is a damper device which can restrict the swinging of a rod in the width direction and thickness direction thereof with a simple structure. This damper device 10 has a cylinder 20, a piston rod 30, and a guide cap 70, and the piston rod 30 has a rod 40 and a piston 60. The rod 40 is of a plate shape. The guide cap 70 has an insertion wall part 71 inserted inside an opening 23 of the cylinder 20, an insertion hole 73 into which the rod 40 is inserted, and an elastic piece 77 that is elastically deformable. A convex curved surface 80 and a concave curved surface 50 are formed between the rod 40 and the elastic piece 77, and the concave curved surface 50 provided to the rod 40 extends in the axial direction and is configured to guide the axial direction movement of the piston rod 30.

### TECHNICAL FIELD

The present invention relates to a damper device used to brake opening, closing, and the like of a glove box of an automobile.

### BACKGROUND ART

A damper device may be used in, for example, a glove box of an automobile to prevent a lid from being rapidly opened and allow the lid to be gently opened.

Such a damper device usually has a cylinder and a piston rod that moves within the cylinder, and the piston rod includes a rod and a piston. In addition, the rod may have a plate shape, and in this case, when the piston rod moves in the cylinder, the piston rod may wobble in a width direction or a thickness direction of the rod.

In order to restrict such “wobbling”, Patent Literature 1 below discloses an air damper having a cylinder, a rod which is inserted into the cylinder and whose moving speed is restricted, a through hole formed in the cylinder and configured to allow the rod to enter and exit from the cylinder without coming into contact with the rod, and an elastic member which is provided at an edge portion of the through hole and holds a state of contact with the rod.

The through hole is an elongated hole, and three thin plate-shaped elastic tongue pieces are provided standing up from a peripheral edge of each of both end portions in a longitudinal direction. That is, a pair of elastic tongue pieces are arranged to face each other in the longitudinal direction of the through hole, and a pair of elastic tongue pieces are arranged to face each other at positions orthogonal to the longitudinal direction at each of the both end portions in the longitudinal direction of the through hole, so that a total of six elastic tongue pieces are provided. The pair of elastic tongue pieces arranged to face each other in the longitudinal direction of the through hole restrict the rod from wobbling in the longitudinal direction of the through hole, and the pair of elastic tongue pieces arranged orthogonal to the longitudinal direction at each of the both end portions in the longitudinal direction of the through hole restrict the rod from wobbling in a direction orthogonal to the longitudinal direction of the through hole (see paragraph 0016 of Patent Literature 1).

### CITATION LIST

### Patent Literature

Patent Literature 1: JPH04-96634U

### SUMMARY OF INVENTION

### Technical Problem

In a case of the air damper disclosed in Patent Literature 1, since six elastic tongue pieces are provided on the peripheral edges of both end portions in the longitudinal direction of the through hole, the structure is complicated.

Therefore, it is an object of the present invention to provide a damper device that is capable of restricting wobbling of a rod in a width direction or a thickness direction with a simple structure.

### Solution to Problem

In order to achieve the above object, the present invention relates to a damper device configured to be attached between a pair of members that are configured to approach and separate from each other, and configured to apply a braking force when the pair of members approach or separate from each other, the damper device including: a cylinder having an opening portion at one end portion; a piston rod movably inserted into the cylinder through the opening portion; and a guide cap attached to the opening portion of the cylinder. The piston rod include a rod and a piston coupled to the rod. The cylinder has a tubular wall portion, and a cross section of the wall portion orthogonal to a moving direction of the piston has a shape having a long axis and a short axis. The piston is shaped to have a long axis and a short axis to fit with an inner periphery of the wall portion of the cylinder. When viewed from an axial direction, the rod has a long axis along a long axis direction of the piston and a short axis orthogonal to the long axis, and has a plate shape extending by a predetermined length. The guide cap includes an insertion wall portion inserted into the opening portion of the cylinder, an insertion hole into which the rod is inserted, and an elastically deformable elastic piece portion provided in a portion of the insertion wall portion facing the rod. One of the rod or the elastic piece portion is formed with a convex portion, and another of the rod or the elastic piece portion is formed with a concave portion that allows the convex portion to enter and come into contact therewith. The convex portion or the concave portion provided on the rod extends in the axial direction and is configured to guide an axial movement of the piston rod. Of contact portions between the convex portion and the concave portion, at least one contact portion on a side of the convex portion or on a side of the concave portion is a curved surface.

### Advantageous Effects of Invention

In the present invention, the axial movement of the piston rod is guided by the convex portion and the concave portion that allows the convex portion to enter and come into contact with, so that wobbling of the rod in a thickness direction and a width direction during the movement of the piston rod in the cylinder can be restricted with a simple structure.

### BRIEF DESCRIPTION OF DRAWINGS

FIG. 1 is an exploded perspective view showing a damper device according to a first embodiment of the present invention.

FIG. 2 is a perspective view of the damper device in a state where a piston is pressed in.

FIG. 3 is a cross-sectional view taken along a line D-D of FIG. 2.

FIG. 4 is a side view of a piston rod included in the damper device.

FIG. 5 is an enlarged perspective view of a main portion of the piston rod included in the damper device.

FIG. 6 is a cross-sectional view taken along a line E-E of FIG. 2.

FIG. 7 is an enlarged perspective view of a main portion of a guide cap in half cross section that shows a relationship between a rod and the guide cap in the damper device.

FIG. 8 is a perspective view of the guide cap included in the damper device.

FIG. 9 is a perspective view of the guide cap included in the damper device when viewed from a direction different from that of FIG. 8.

FIG. 10 is a back view of the guide cap included in the damper device.

FIG. 11 is a cross-sectional view taken along a line G-G of FIG. 2.

FIG. 12 is an enlarged cross-sectional view of a part J in FIG. 11.

FIG. 13 is a cross-sectional view taken along a line I-I of FIG. 2.

FIG. 14 is an enlarged perspective view of a main portion of a guide cap in half cross section that shows a relationship between a rod and the guide cap in a damper device according to a second embodiment of the present invention.

FIG. 15 is a perspective view of the guide cap included in the damper device.

FIG. 16 is an enlarged cross-sectional view of a main portion of the damper device.

FIG. 17 is an enlarged perspective view of a main portion of a rod included in a damper device according to a third embodiment of the present invention.

FIG. 18 is an enlarged perspective view of main portions of a cylinder and a guide cap which are included in the damper device, with the cylinder and the guide cap shown in half cross section.

FIG. 19 is an enlarged cross-sectional view of a main portion of the damper device.

FIG. 20 is an enlarged perspective view of a main portion of a rod included in a damper device according to a fourth embodiment of the present invention.

FIG. 21 is an enlarged cross-sectional view of a main portion of the damper device.

FIG. 22 is an enlarged perspective view of a main portion of a rod included in a damper device according to a fifth embodiment of the present invention.

FIG. 23 is an enlarged perspective view of main portions of a cylinder and a guide cap which are included in the damper device, with the cylinder and the guide cap shown in half cross section.

FIG. 24 is an enlarged cross-sectional view of a main portion of the damper device.

FIG. 25 is an enlarged perspective view of a main portion of a rod included in a damper device according to a sixth embodiment of the present invention.

FIG. 26 is an enlarged perspective view of main portions of a cylinder and a guide cap which are included in the damper device, with the cylinder and the guide cap shown in half cross section.

FIG. 27 is an enlarged cross-sectional view of a main portion of the damper device.

FIG. 28 shows modifications of the third to sixth embodiments of the damper device according to the present invention, in which (a) is a schematic view illustrating a first modification, (b) is a schematic view illustrating a second modification, (c) is a schematic view illustrating a third modification, and (d) is a schematic view illustrating a fourth modification.

### DESCRIPTION OF EMBODIMENTS

### Damper Device According to First Embodiment

Hereinafter, a damper device according to a first embodiment of the present invention will be described with reference to the drawings.

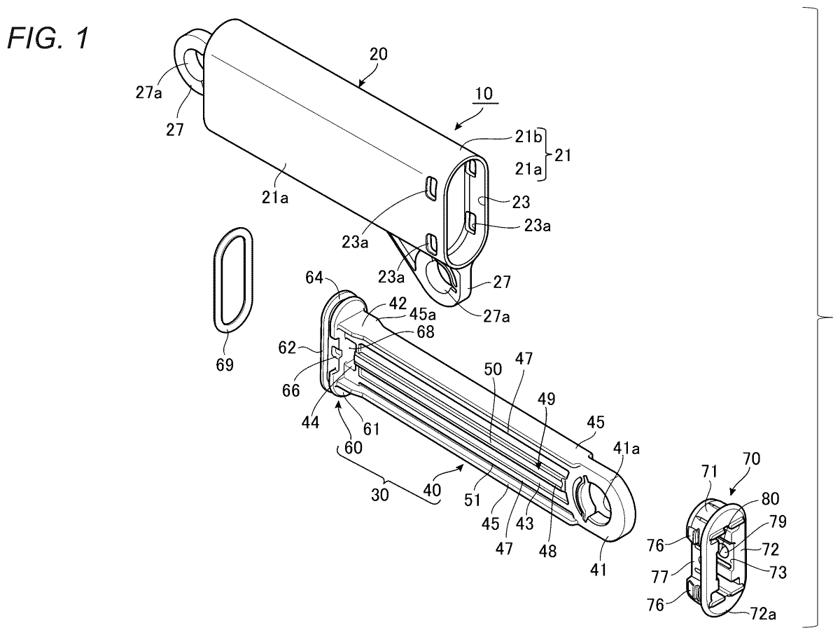

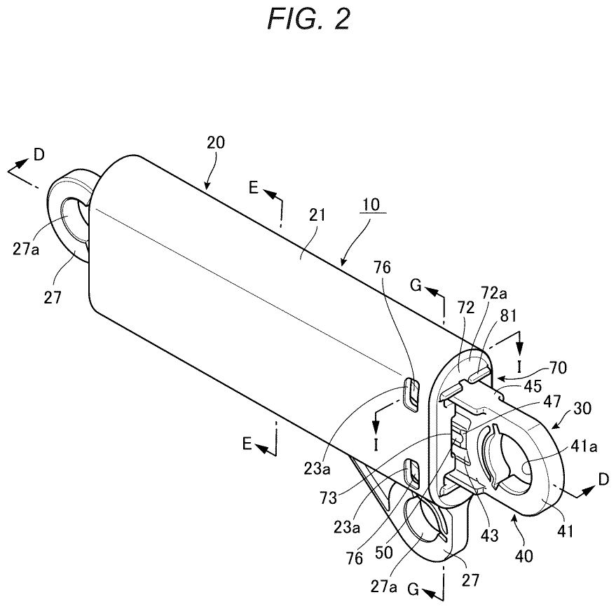

A damper device 10 shown in FIGS. 1 and 2 is attached to a pair of members that approach and separate from each other, and applies a braking force when the pair of members approach or separate from each other. For example, the damper device 10 can be used to brake a glove box, a lid, or the like that is attached to an opening portion of an accommodation portion in an instrument panel of an automobile in a manner of being openable and closable. In the following embodiment, one of the pair of members is described as a fixed body such as the accommodation portion of the instrument panel, and another of the pair of members is described as an openable and closable body such as the glove box or the lid attached to the opening portion of the fixed body in a manner of being openable and closable.

As shown in FIG. 1, the damper device 10 according to the embodiment includes a cylinder 20 provided with an opening portion 23 at one end portion, a piston rod 30 movably inserted into the cylinder 20, and a guide cap 70 attached to the opening portion 23 of the cylinder 20. The piston rod 30 includes a rod 40 and a piston 60 connected to the other end portion 42 side of the rod 40 in an axial direction. The rod 40 and the piston 60 move within the cylinder 20 as the piston rod 30 moves.

Further, between the rod 40 and an elastic piece portion 77 of the guide cap 70, one of the rod 40 and the elastic piece portion 77 is formed with a convex portion, and another is formed with a concave portion into which the convex portion enters and comes into contact. The convex portion or the concave portion provided in the rod 40 extends in the axial direction, and is configured to guide axial movement of the piston rod 30. Further, at least one of contact portions between the convex portion and the concave portion has a curved surface on a convex portion side or a concave portion side.

Further, in this embodiment, the convex portion has a convex curved surface forming the curved surface, and the concave portion has a concave curved surface forming the curved surface. The convex curved surface and the concave curved surface are to come into contact with each other.

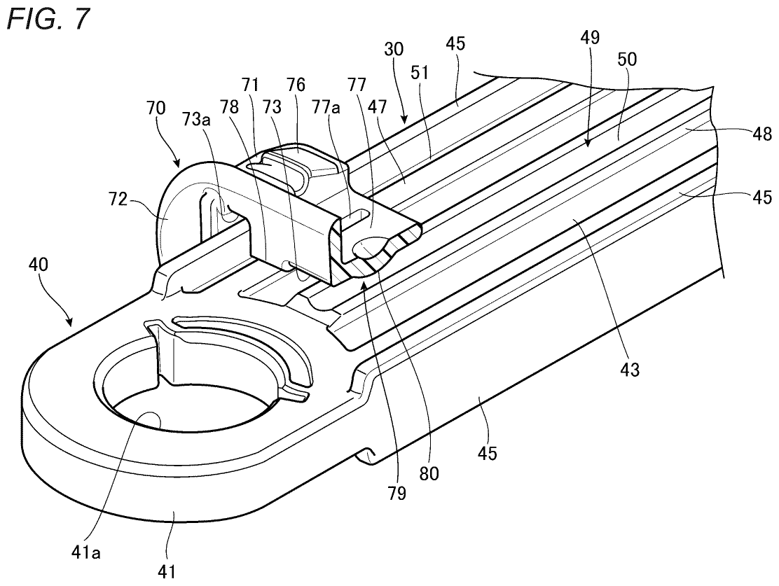

In this embodiment, as shown in FIG. 7, a concave portion is formed on the rod 40, a concave curved surface 50 forming a curved surface is provided in the concave portion, and the concave curved surface 50 extends in the axial direction. Meanwhile, a convex portion 79 is formed on the guide cap 70, and a convex curved surface 80 forming a curved surface is provided in the convex portion 79.

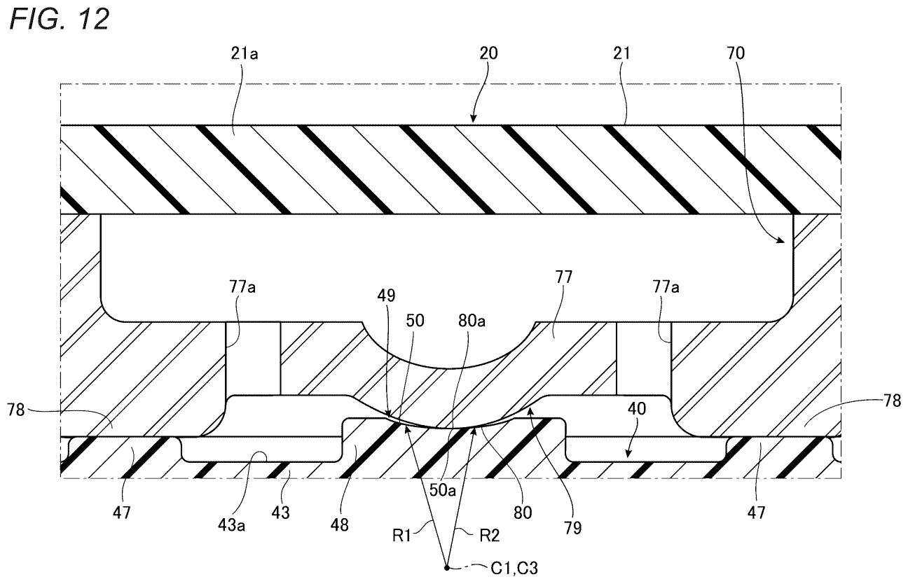

Further, in the damper device 10, in a state where the piston rod 30 is inserted into the cylinder 20 and the guide cap 70 is attached to the opening portion 23 of the cylinder 20, the convex curved surface and the concave curved surface constantly abut against each other either by the concave curved surface pressing against the convex curved surface to elastically deform the elastic piece portion 77, or by the convex curved surface pressing against the concave curved surface to elastically deform the elastic piece portion 77. In this embodiment, as shown in FIG. 12, the convex curved surface 80 and the concave curved surface 50 constantly abut against each other by the concave curved surface 50 pressing against the convex curved surface 80 to elastically deform the elastic piece portion 77.

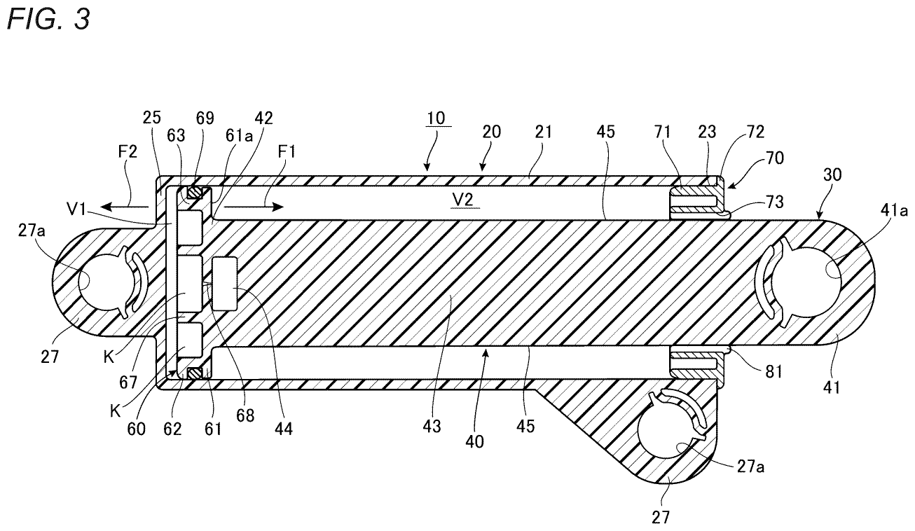

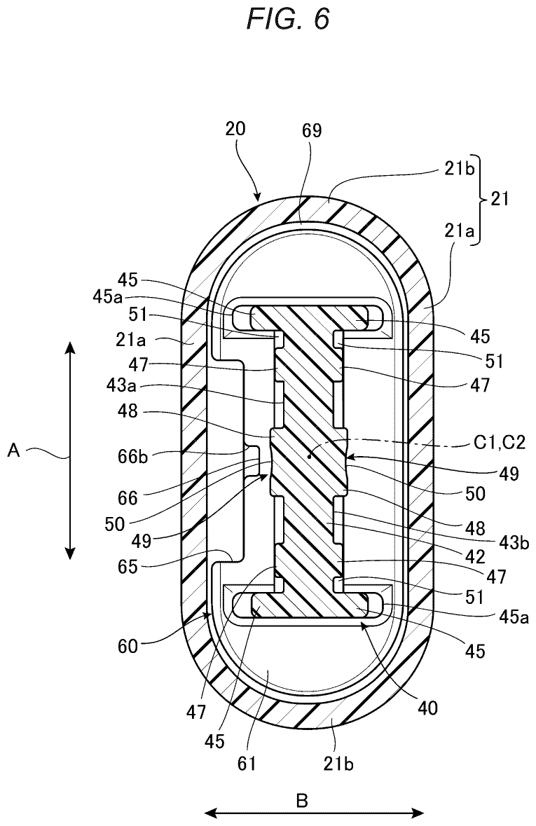

Further, a seal ring 69 is attached to an outer periphery of the piston 60, and an air chamber is formed in the cylinder 20 via the seal ring 69 (seal portion). In the case of this embodiment, the air chamber is formed in the cylinder 20 on a side of an insertion direction of the piston rod 30 with respect to the seal portion. That is, as shown in FIG. 3, when the piston 60 is inserted into the cylinder 20, the seal ring 69 is pressed against an inner peripheral surface of the cylinder 20. As a result, the seal ring 69 defines a first air chamber V1 and a second air chamber V2 are formed in the cylinder 20 with the seal ring 69 being a boundary, the first air chamber V1 is formed on the side of the insertion direction of the rod 40, and the second air chamber V2 is formed on a side of the opening portion 23 of the cylinder 20. In the case of this embodiment, the inner peripheral surface of the cylinder 20 refers to the inner peripheral surface of a wall portion 21 (see FIG. 6 and the like) forming the cylinder 20, and this also applies to the following description.

In the following description, “one end portion” or “one end” refers to one end portion or one end of the damper device 10 on a damper braking direction side, and “another end portion” or “another end” refers another end portion or another end on a return direction side opposite to the damper braking direction side. Further, the “damper braking direction” in the present embodiment refers to a direction in which the piston 60 separates from an end portion wall 25 (see FIG. 3) of the cylinder 20 and an amount of the rod 40 pulled out from the opening portion 23 of the cylinder 20 increases (see an arrow F1 in FIG. 3). In addition, the “return direction opposite to the damper braking direction” (hereinafter, also simply referred to as “damper return direction”) in the present embodiment refers to a direction in which the piston 60 approaches the end portion wall 25 of the cylinder 20 and an amount of the rod 40 pressed into the cylinder 20 increases (see an arrow F2 in FIG. 3).

As shown in FIG. 1, the cylinder 20 has the wall portion 21 extending in a tubular shape. Referring also to FIG. 6, the wall portion 21 has a cross section (also referred to as a cross section orthogonal to the axial direction of the cylinder 20) orthogonal to a moving direction of the piston 60 (the direction along a damper braking direction F1 and a damper return direction F2) that is annular with a long axis A and a short axis B, and has a thin tubular shape (a tubular shape resembling a thin box) having a wide side on the long axis A side and a narrow side on the short axis B side. More specifically, the wall portion 21 in the present embodiment includes a pair of long axis wall portions 21a and 21a that extend linearly in a direction along the long axis A and are arranged to face each other in parallel to each other, and a pair of short axis wall portions 21b and 21b that are arranged on the short axis B side, have a shape bent in an arc shape, and couple both end portions of the long axis wall portions 21a and 21a.

The direction along the long axis A of the cylinder 20 may be referred to as “width direction”, and a direction along the short axis B orthogonal to the long axis A of the cylinder 20 may be referred to as “thickness direction”. The meanings of the “width direction” and the “thickness direction” are the same for the piston rod 30 and each of the members forming the piston rod 30, such as the rod 40, the piston 60, the guide cap 70, which will be described below. It can also be said that the cylinder 20 has a flat tubular shape whose width is larger than the thickness.

Corresponding to the shape of the wall portion 21 described above, the piston 60 also has a shape with the long axis A and the short axis B that fits with the inner periphery of the wall portion 21 of the cylinder 20 (which will be described in detail later).

One end portion side in the axial direction of the wall portion 21 of the cylinder 20 is opened, and the opening portion 23 is provided. The long axis wall portions 21a and 21a arranged to face each other at a peripheral edge of the opening portion 23 are formed with engaging holes 23a and 23a, respectively. Here, a total of four engaging holes 23a are formed. Further, as shown in FIG. 3, the end portion wall 25 is disposed at another end portion of the wall portion 21 in the axial direction to close another end portion of the wall portion 21.

In addition, a rotation support piece 27 having a rotation hole 27a formed therein protrudes from each of an outer surface of the end portion wall 25 and one end portion of an outer periphery of the wall portion 21 in the axial direction. A rotating shaft (not shown) of the one member described above is rotatably inserted into the predetermined rotation hole 27a, and an outer periphery of the cylinder 20 is rotatably coupled to the one member.

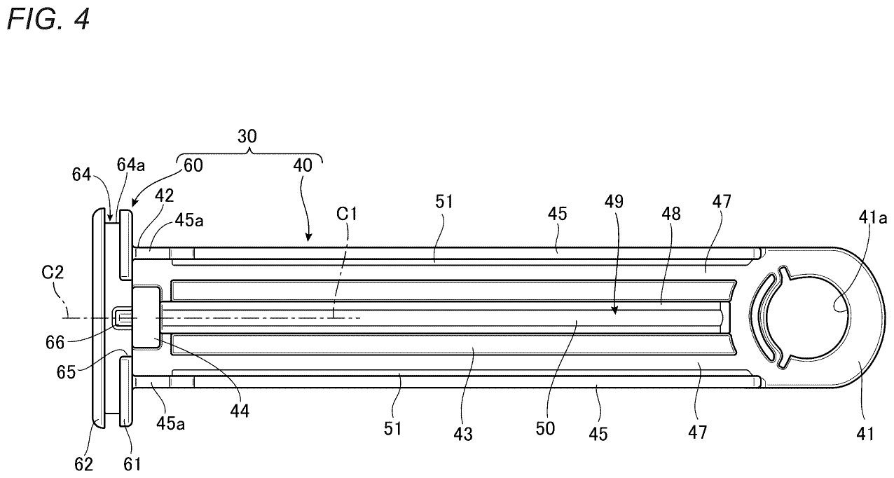

Next, the rod 40 will be described with reference to FIGS. 4 to 7, FIGS. 11 and 12, and the like.

The rod 40 is movably inserted into the cylinder 20 through the opening portion 23 of the cylinder 20, and slides in the cylinder 20 in the axial direction of the cylinder 20.

As shown in FIGS. 1 and 4, the rod 40 of the present embodiment extends a predetermined length, a rotation hole 41a is formed in one end portion 41 in the axial direction, and the piston 60 is coupled to another end portion 42 in the axial direction. The axial direction of the rod 40 refers to a direction along an axial center C1 (see FIG. 4) of the rod 40. A coupling shaft (not shown) of the other member described above is rotatably inserted into the rotation hole 41a formed in the one end portion 41, and the rod 40 is rotatably coupled to the other member.

Further, as shown in FIG. 6, the rod 40 has a cross-sectional shape with the long axis A and the short axis B, similarly to the wall portion 21 of the cylinder 20 and the piston 60. That is, the rod 40 has a plate shape having a cross section that is long in the direction of the long axis A of the piston 60 when the piston 60 is viewed from the axial direction.

The rod 40 includes a shaft portion 43 in the shape of a long plate extending by a predetermined length. At the other end portion 42 in the axial direction of the rod 40, a substantially quadrangular through hole 44 is formed penetrating the rod 40 in the thickness direction.

Ribs 45 are provided on both sides of surfaces 43a, 43a of the rod 40 along the long axis A, stand up in a direction orthogonal to the surface 43a along the long axis A, and extend in the axial direction. That is, as shown in FIG. 6, the ribs 45 are provided on both side portions in the direction of the long axis A (width direction) of the shaft portion 43 of the rod 40, that is, the surfaces 43a and 43b (both surfaces 43a and 43b in the thickness direction) along the long axis A, and stand up (protrude) in the direction of the short axis B (thickness direction) so as to be orthogonal to the surface 43a along the long axis A. The ribs 45 extend along the axial direction of the rod 40. Here, a pair of ribs 45 and 45 are provided in the width direction on one surface of the rod 40 in the thickness direction, and a pair of ribs 45 and 45 are also provided in the width direction on another surface in the thickness direction, and a total of four ribs 45 are provided. As a result, the rod 40 has a substantially H-shaped cross-sectional shape when viewed in the axial direction.

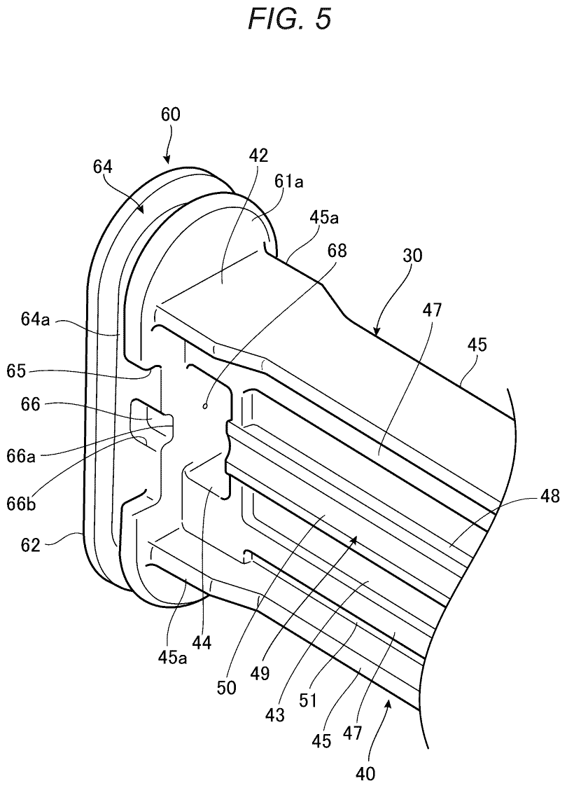

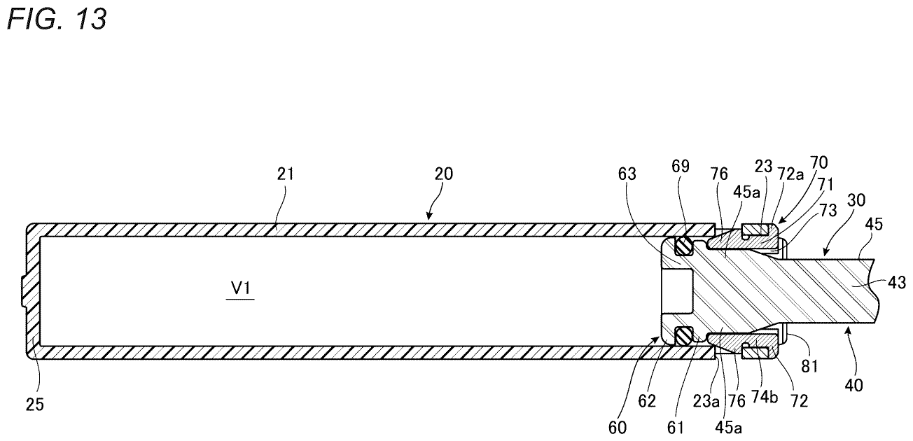

Further, a portion of the rib 45 located on the piston 60 side is provided with a standing portion 45a standing higher than other portions of the rib 45 (see FIG. 5), and the standing portion 45a can come into contact with an inner peripheral surface of both end portions of an insertion hole 73 of the guide cap 70 (see FIG. 13).

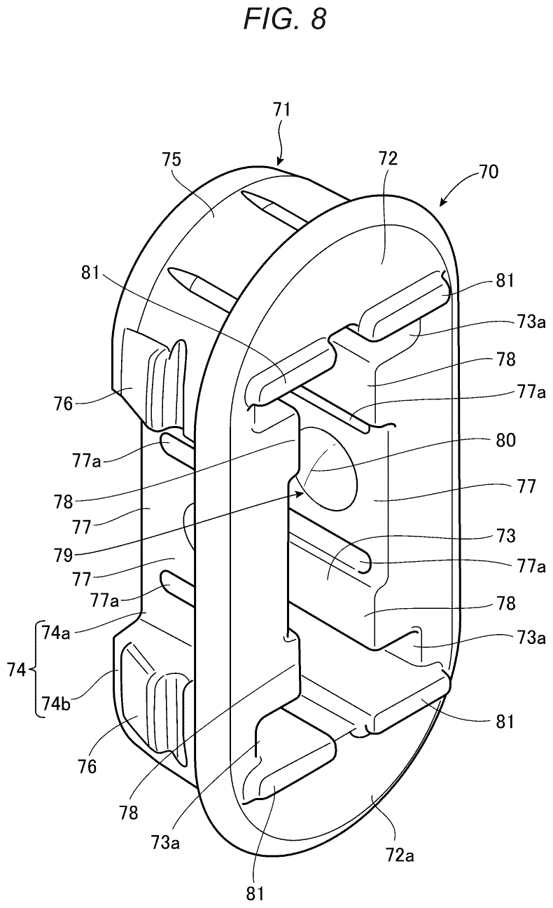

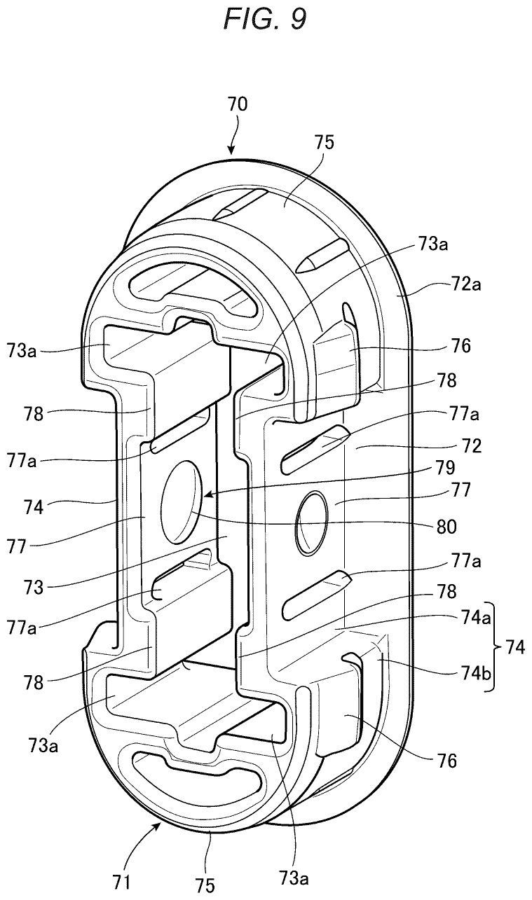

In this embodiment, each rib 45 is provided with the standing portion 45a, which stands higher than other portions, at a portion coupled to the piston 60, that is, another end portion in the axial direction. When the piston rod 30 is pulled from the cylinder 20 to the maximum limit, that is, when the piston 60 moves to a farthest position from the end portion wall 25 of the cylinder 20 and an amount of the rod 40 pulled out from the opening portion 23 of the cylinder 20 becomes maximum as shown in FIG. 13, the standing portion 45a of the rib 45 comes into contact with the inner peripheral surface of both end portions of the insertion hole 73 formed in the insertion wall portion 71 of the guide cap 70. Specifically, the standing portions 45a and 45a of the ribs 45 are disposed to face the inner peripheral surfaces of both end portions of the insertion hole 73 in the long axis A direction, that is, inner peripheral surfaces of both side portions 74b and 74b (see FIGS. 8 and 9) in the width direction of the long axis wall portion 74 forming the insertion wall portion 71, and can come into contact with the inner peripheral surfaces.

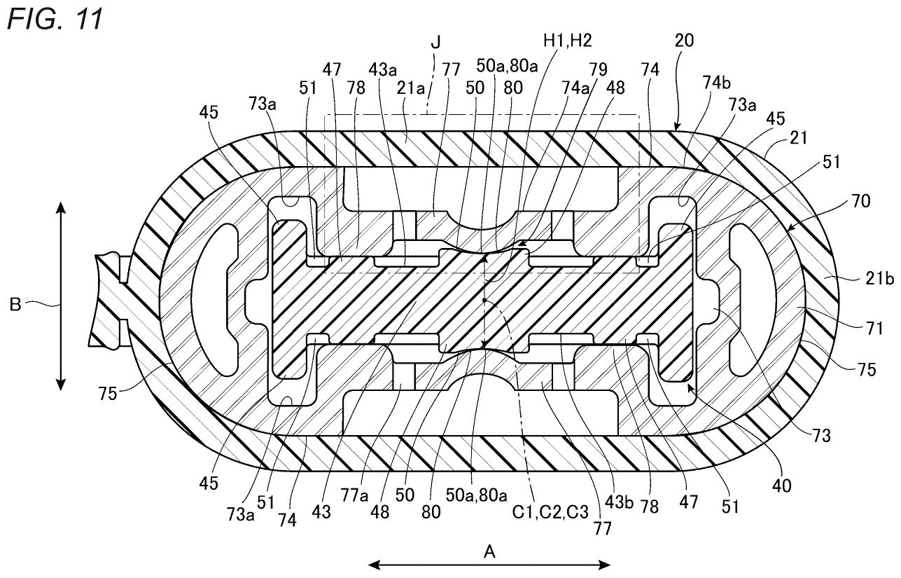

Further, as shown in FIG. 11, the rod 40 includes a pair of rod side guide portions 47 and 47 which extend in the axial direction and are disposed to face a pair of cap side guide portions 78 and 78 provided on the guide cap 70, and a protruding portion 48 which protrudes toward the guide cap 70 from protruding surfaces of the pair of rod side guide portions 47 and 47 and is inserted between the pair of cap side guide portions 78, 78 and extends in the axial direction, and the concave curved surface 50 is provided on the protruding portion 48.

Specifically, the pair of rod side guide portions 47 and 47 each having a protruding shape extend along the axial direction of the rod 40 from respective positions on the surfaces 43a and 43b of the shaft portion 43 in the thickness direction and on an inner side in the width direction with respect to the pair of ribs 45 and 45 located on both sides in the width direction. Here, a total of four rod side guide portions 47 are provided, one pair on each of both surfaces 43a and 43b in the thickness direction of the shaft portion 43. Each of the rod side guide portions 47 has a protruding surface (tip surface in a protruding direction) of a flat surface shape, and is disposed to face the cap side guide portion 78 provided in the guide cap 70 to guide the piston rod 30 during axial movement.

In addition, the protruding portions 48 each having a protruding shape that protrude from both surfaces 43a and 43b in the thickness direction of the shaft portion 43 and extend along the axial direction are provided at the center portion in the width direction. The protruding surface (tip surface in the protruding direction, surface facing the inner peripheral surface of the cylinder 20) of each of the protruding portions 48 protrudes higher toward the guide cap 70 than the protruding surfaces of the pair of rod side guide portions 47 and 47, and the protruding surface is formed with a rod side concave groove 49 extending along the axial direction of the rod 40 and forming a “concave portion” according to the present invention. As shown in FIGS. 1 and 3, the rod side concave groove 49 is formed over the entire length in the axial direction of the protruding portion 48.

The concave curved surface 50 is formed on an inner surface of the rod side concave groove 49 (a surface facing the inner peripheral surface of the cylinder 20 and an inner peripheral surface of the insertion wall portion 71 of the guide cap 70). The concave curved surface 50 extends in the axial direction of the rod 40. The convex curved surface 80 provided on the guide cap 70 fits into and comes into sliding contact with this concave curved surface 50, and the axial movement of the piston rod 30 is guided (this will be described in detail in the description of the convex curved surface 80).

As shown in FIG. 12 and the like, the concave curved surface 50 in this embodiment is a concave R curved surface that is recessed toward the axial center C1 of the rod 40 (recessed in a direction away from the inner peripheral surface of the cylinder 20 and the inner peripheral surface of the insertion wall portion 71 of the guide cap 70) while drawing an R-shaped curved surface. The concave curved surface 50 extends over the entire length in the axial direction of the rod side concave groove 49 (see FIGS. 1 and 3). The curvature radius of the concave curved surface 50 with respect to the axial center C1 of the rod 40 is defined as “R1” (see FIG. 12).

A groove 51 extending along the axial direction is formed on a surface of the rod 40 along the long axis A, that is, on both surfaces 43a and 43b in the thickness direction of the shaft portion 43, between each rib 45 and each rod side guide portion 47 (see FIGS. 4 and 11). Here, a total of four grooves 51 are provided on both surfaces 43a and 43b in the thickness direction of the shaft portion 43, one on each side in the width direction.

Next, the piston 60 will be described.

As shown in FIG. 1 and FIG. 3, the piston 60 of the present embodiment is coupled to the other end portion 42 in a longitudinal direction of the rod 40, an annular groove 64 is formed on the outer periphery of the piston 60, and the piston 60 is integrally formed with the rod 40.

The seal ring 69 formed in an annular shape and made of an elastic material such as rubber or elastomer is attached to the annular groove 64. The seal ring 69 is constantly pressed against the inner peripheral surface of the cylinder 20. Note that “constantly” refers to all states in which the piston 60 is within the cylinder 20, that is, a state in which the piston 60 is stationary, a state in which the piston 60 is moved in the damper braking direction F1, and a state in which the piston 60 is moved in the damper return direction F2 (the same applies to the relationship between the convex curved surface 80 and the concave curved surface 50).

As shown in FIGS. 3 and 5, the piston 60 includes a first side wall portion 61 and a second side wall portion 62 that are arranged to face each other and be parallel to each other, and a connection wall portion 63 that connects the two side wall portions 61 and 62 to each other.

Further, the piston 60 has a shape with the long axis A and the short axis B that fits with the inner periphery of the wall portion 21 of the cylinder 20. Specifically, as shown in FIG. 6, both side surfaces in the direction of the long axis A are parallel to each other and both side surfaces in the direction of the short axis B are arc-shaped so that each of the side wall portions 61 and 62 forming the piston 60 are adapted to fit with the shape of the inner periphery of the wall portion 21 of the cylinder 20. Further, an outer periphery of the connection wall portion 63 has a similar shape smaller than the outer peripheries of the two side wall portions 61 and 62.

The other end portion 42 of the rod 40 in the axial direction is coupled to a coupling surface 61a (outer surface) of the first side wall portion 61, so that the piston 60 and the rod 40 are integrated. An axial center C2 of the piston 60 coincides with the axial center C1 of the rod 40. Further, a space surrounded by the pair of side wall portions 61 and 62 and the connection wall portion 63 forms the annular groove 64. Further, an outer peripheral surface of the connection wall portion 63 forms a bottom surface 64a of the annular groove 64.

Further, as shown in FIG. 5, a notch portion 65 that is cut out to a predetermined width is provided on one (side) of portions of the first side wall portion 61 extending along the long axis A. When the piston 60 moves in the damper return direction F2, a part of the seal ring 69 enters the notch portion 65 (this will be described later).

Further, as shown in FIG. 5, a concave groove 66 in which a groove has a concave shape is formed in the bottom surface 64a of the annular groove 64 and a bottom surface of the notch portion 65. An opening 66a on one end side of the concave groove 66 extends to the coupling surface 61a of the first side wall portion 61 of the piston 60 that couples with the rod 40, and communicates with the through hole 44. Further, an opening 66b (upper opening) of the concave groove 66, which is a portion positioned in the annular groove 64 and is positioned on a piston outer peripheral side, is closed by the seal ring 69 (the opening 66b is closed except when a part of the seal ring 69 is deformed as described below). When the piston 60 moves in the damper return direction F2 and a part of the seal ring 69 is deformed to enter the notch portion 65, the opening 66b of the concave groove 66 opens. When the piston 60 moves in the damper return direction F2, the concave groove 66 forms an exhaust flow path (which will be described later) that exhausts the air in the first air chamber V1 to the second air chamber V2.

Further, as shown in FIG. 3, a plurality of spaces K defined by a partition wall 67 are provided inside the both side wall portions 61 and 62 and the connection wall portion 63, and each space K is opened on the second side wall portion 62 side. An orifice 68 communicating with the through hole 44 is formed in the piston 60. The orifice 68 has another end communicating with the first air chamber V1 via the space K, and one end communicating with the through hole 44 (see FIG. 3). That is, the orifice 68 allows the first air chamber V1 and the second air chamber V2 in the cylinder 20 to communicate with each other via the spaces K. A braking force of the damper is adjusted by flow resistance of the air flowing through the orifice 68.

Next, the guide cap 70 will be described with reference to FIGS. 7 to 13 and the like.

Further, the guide cap 70 includes the insertion wall portion 71 inserted into the opening portion 23 of the cylinder 20, the insertion hole 73 into which the rod 40 is inserted, and the elastically deformable (bendable) elastic piece portion 77 provided on the insertion wall portion 71 at a position facing the rod 40.

The insertion wall portion 71 has a shape with the long axis A and the short axis B so as to fit with the wall portion 21 of the cylinder 20. Specifically, the insertion wall portion 71 includes a pair of long axis wall portions 74 and 74 that extend linearly in a direction along the long axis A and are arranged to face each other in parallel to each other, and a pair of short axis wall portions 75 and 75 that are arranged on the short axis B side, have a shape bent in an arc shape, and couple both end portions of the long axis wall portions 74 and 74. As shown in FIG. 11, the pair of long axis wall portions 74 and 74 are disposed inside the pair of long axis wall portions 21a and 21a of the cylinder 20, and are disposed outside the surface along the long axis A (surface along the width direction) of the rod 40. On the other hand, the pair of short axis wall portions 75 and 75 are disposed inside the pair of short axis wall portions 21b and 21b of the cylinder 20, and are disposed outside the surface along the short axis B (surface along the thickness direction) of the rod 40.

Further, a cover wall portion 72 having an insertion hole 73 formed therein is connected to one end in the axial direction of the insertion wall portion 71. The cover wall portion 72 has a substantially oval shape in which arcuate surfaces are provided on both side portions in the width direction so as to fit with the opening portion 23 of the cylinder 20. An outer peripheral edge portion 72a of the cover wall portion 72 protrudes from an outer peripheral edge portion of the insertion wall portion 71 by a predetermined length (protrudes like a flange). When the guide cap 70 is attached to the opening portion 23 of the cylinder 20, the outer peripheral edge portion 72a of the cover wall portion 72 comes into contact with one end surface of the wall portion 21 of the cylinder 20 (see FIG. 13).

Further, intermediate portions 74a, 74a in the width direction of the pair of long axis wall portions 74, 74 forming the insertion wall portion 71 are recessed so as to approach each other. Inner surfaces of the intermediate portions 74a, 74a (surfaces of the guide cap 70 facing inward in a radial direction, and also referred to as opposing surfaces) are parallel to each other.

Further, the guide cap 70 has an engaging claw 76 that is formed to be bendable and deformable and engages with the engaging hole 23a provided in the opening portion 23 of the cylinder 20 from an inner periphery thereof. The engaging claw 76 is disposed at a position corresponding to the outside of the standing portion 45a of the rib 45 provided in the rod 40.

Here, the engaging claws 76 are provided to protrude from the outer surfaces (surfaces facing outward in the radial direction of the guide cap 70) of both side portions 74b, 74b in the width direction of each long axis wall portion 74. Here, a total of four engaging claws 76 are provided. The engaging claws 76 are disposed at positions corresponding to the outer side of the standing portions 45a of the ribs 45 provided on the rod 40 (see FIGS. 1 and 13). When passing through the opening portion 23 of the cylinder 20, a top portion of each engaging claw 76 is pressed by the wall portion 21 of the cylinder 20, so that the engaging claw 76 is bent and deformed inward of the guide cap 70 (the engaging claw 76 is bent and deformed together with both side portions 74b of the long axis wall portion 74). The insertion wall portion 71 of the guide cap 70 is inserted into the opening portion 23 of the cylinder 20 and pushed in while bending the engaging claws 76, and the corresponding engaging claws 76 of the guide cap 70 are engaged with the engaging holes 23a of the opening portion 23 from the inner periphery, so that the guide cap 70 is attached to the opening portion 23 of the cylinder 20 as shown in FIG. 2.

A pair of slits 77a, 77a extending along the axial direction and arranged parallel to each other are formed in the intermediate portion 74a of each long axis wall portion 74 of the insertion wall portion 71, and the elastic piece portions 77 are formed to be bendable and deformable via the pair of slits 77a and 77a. The elastic piece portion 77 is provided at a position corresponding to the rod side concave groove 49 of the rod 40 (see FIG. 12).

Further, on both sides of the elastic piece portion 77, the pair of cap side guide portions 78 and 78 protruding so as to face surfaces of the rod 40 in the direction along the long axis A are provided.

Specifically, as shown in FIGS. 8 to 10, the pair of cap side guide portions 78, 78 extend along the axial direction of the guide cap 70 from inner surfaces (surfaces facing the surfaces of the rod 40 along the long axis A) of both side portions in the width direction of the intermediate portion 74a of each long axis wall portion 74 of the insertion wall portion 71. Here, a total of four cap side guide portions 78 are provided. The cap side guide portions 78 each have a protruding surface (tip surface in the protruding direction) with a flat surface shape, and are provided over the entire cap length of the guide cap 70 from one end to another end in the axial direction (across the cover wall portion 72 and the insertion wall portion 71). The cap side guide portions 78 are arranged to face the rod side guide portions 47 provided on the rod 40 with a predetermined gap therebetween (see FIG. 11). The cap side guide portions 78 and the rod side guide portions 47 guide the piston rod 30 when the piston rod 30 moves in the axial direction.

The convex portion 79 protrudes from an inner surface (a surface facing the surface of the rod 40 along the long axis A) of each elastic piece portion 77, and the convex curved surface 80 is provided on a top portion of the convex portion 79.

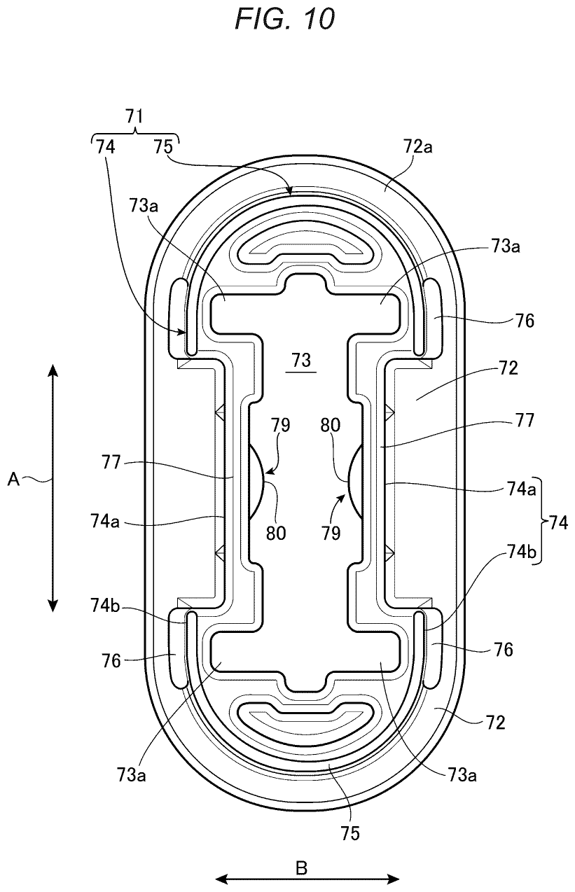

More specifically, as shown in FIGS. 8 and 9, the convex portion 79 is disposed on the inner surface of the elastic piece portion 77 at the center in the width direction (direction along the long axis A) and at the center in the axial direction. Further, as shown in FIG. 12, the convex portion 79 is convex from the inner surface of the elastic piece portion 77 toward an axial center C3 of the guide cap 70 while drawing an R-shaped curved surface (has a shape protruding in a spherical shape that is convex toward the surface of the rod 40 along the long axis A). The top portion of the convex portion 79 is also a convex R curved surface drawing the R-shaped curved surface, and the top portion forms the convex curved surface 80. Further, the pair of convex portions 79 and 79 are arranged such that the convex curved surfaces 80 and 80 face each other (see FIGS. 10 and 11).

The convex curved surface 80 fits into the concave curved surface 50 on the rod 40 side and comes into contact with and slides against the concave curved surface 50, thereby guiding the axial movement of the piston rod 30.

In the damper device 10, in a state where the piston rod 30 is inserted into the cylinder 20 and the guide cap is attached to the opening portion 23 of the cylinder 20, as shown in FIGS. 11 and 12, the concave curved surface 50 on the rod 40 side which does not elastically deform presses against the convex curved surface 80 on the elastic piece portion 77 side of the guide cap 70 to elastically deform the elastic piece portion 77 (although not shown, the elastic piece portion 77 is slightly elastically deformed), and due to the elastic restoring force, the convex curved surface 80 on the elastic piece portion 77 side presses against the concave curved surface 50 on the rod 40 side. As a result, the convex curved surface 80 and the concave curved surface 50 are brought into contact with each other in a state of being engaged with each other in a concave-convex manner. Here, the apex 80a of the convex curved surface 80 and a peripheral edge portion thereof within a predetermined range are brought into contact (surface contact) with the bottom 50a of the concave curved surface 50 as the center (see FIG. 12). Accordingly, when the piston rod 30 moves in the damper braking direction F1 or the damper return direction F2 with respect to the cylinder 20, the piston rod 30 moves while the convex curved surface 80 is in contact with the concave curved surface 50, that is, the concave curved surface 50 slides (moves while in sliding contact) on the convex curved surface 80 (the concave curved surface 50 on a side of the piston rod 30, which moves in the axial direction with respect to the cylinder 20, slides on the convex curved surface 80 on a side of the guide cap 70, which is mounted and fixed to the opening portion 23 of the cylinder 20), thereby guiding the axial movement of the piston rod 30.

Further, as shown in FIG. 11, in this embodiment, when a distance between bottoms 50a and 50a of the pair of concave curved surfaces 50 and 50 provided on both surfaces 43a and 43b in the thickness direction of the rod 40 is defined as “H1” and a distance between apexes 80a and 80a of the pair of convex curved surfaces 80 and 80 disposed to face each other on the insertion wall portion 71 of the guide cap 70 is defined as “H2”, H1>H2 is satisfied. Accordingly, when the piston rod 30 is inserted into the cylinder 20 and the guide cap is attached to the opening portion 23 of the cylinder 20, the pair of concave curved surfaces 50 and 50 press the pair of convex curved surfaces 80 and 80 to elastically deform the pair of elastic piece portions 77 and 77, so that the convex curved surface 80 and the concave curved surface 50 are constantly in contact with each other.

Further, as shown in FIG. 12, when the curvature radius of the convex curved surface 80 with respect to the axial center C3 of the guide cap 70 is “R2”, the curvature radius R2 of the convex curved surface 80 is formed to be smaller than the curvature radius R1 of the concave curved surface 50 (R1>R2). That is, the convex curved surface 80 is a curved surface that draws a steeper curve than the concave curved surface 50. As a result, as shown in FIG. 12, the convex curved surface 80 and the concave curved surface 50 are in contact with each other in a state where a predetermined clearance is generated between the concave curved surface 50 and the convex curved surface 80 (a clearance is generated between the concave curved surface 50 and the apex 80a of the convex curved surface 80 on both sides in a peripheral direction).

Further, the elastic piece portion 77 is disposed at a position away from the rod 40 with respect to the protruding surfaces of the pair of cap side guide portions 78 and 78, and the elastic piece portion 77 is provided with one of the convex curved surface and the concave curved surface.

To describe this more specifically, in this embodiment, the elastic piece portion 77 is disposed at a position lower than the protruding surfaces of the pair of cap side guide portions 78 and 78 (position away from the rod 40). That is, as shown in FIGS. 11 and 12, the elastic piece portion 77 is disposed such that the inner surface thereof is located at a position lower than (retracted position) the protruding surface having a flat surface shape of the cap side guide portion 78. As shown in FIG. 12, the apex 80a of the convex curved surface 80 provided on the elastic piece portion 77 is disposed at a position (also referred to as a lower position or a retracted position) away from the rod 40 with respect to the protruding surface having a flat surface shape of the pair of cap side guide portions 78, 78. The elastic piece portion 77 is provided with the convex portion 79 and the convex curved surface 80, and the entire portion, including the convex portion 79 and the convex curved surface 80, is disposed at a position away from the rod 40 with respect to the protruding surface of the cap side guide portion 78.

The guide cap 70 has insertion grooves 73a formed at both end portions of the insertion holes 73, into which the ribs 45 of the rod 40 are inserted.

Specifically, as shown in FIGS. 8 to 10, from both side portions in the width direction (direction along the long axis A) of the insertion hole 73 formed in the cover wall portion 72, a pair of insertion grooves 73a and 73a are formed by cutting out toward one end in the thickness direction (direction along the short axis B), and a pair of insertion grooves 73a and 73a are also formed by cutting out toward another end in the thickness direction. That is, a total of four insertion grooves 73a are formed, and as a result, when the guide cap 70 is viewed in the axial direction, the insertion hole 73 has a substantially H shape (see FIG. 10). As shown in FIG. 11, the corresponding ribs 45 of the rod 40 are inserted into the insertion grooves 73a, and the rod 40 is guided during the axial movement of the piston rod 30. Further, as shown in FIG. 8, a rod pressing protrusion 81 protrudes from an outer edge portion of each insertion groove 73a on an outer surface side of the cover wall portion 72. When the rod 40 is inclined, the rod pressing protrusion 81 comes into contact with the rib 45 of the rod 40 to restrict the inclination of the rod 40.

### Modifications

The shapes and structures of the cylinder and the piston rod forming the damper device, and the rod, the piston, the seal ring, the orifice and the like forming the piston rod according to the present invention are not limited to the above-described aspects.

The wall portion 21 of the cylinder 20 has a thin tubular shape in this embodiment. Alternatively, the wall portion of the cylinder may have, for example, a substantially elliptical cylindrical shape or the like, and may have any shape having a long axis and a short axis. It is also preferable that the rod, the piston, the guide cap, and the like have a shape corresponding to the wall portion of the cylinder. The rod is required to have a plate shape.

In addition, the cylinder 20 is closed by disposing the end portion wall 25 on the other end portion side in the axial direction in the present embodiment. Alternatively, a through hole may be formed in the end portion wall disposed on the other end portion of the cylinder, for example, and the through hole may be opened and closed by a seal cap.

Further, in the present embodiment, the concave curved surface 50 is provided on the rod 40 side, and the convex curved surface 80 is provided on the elastic piece portion 77 side of the guide cap 70. Alternatively, a convex curved surface may be provided on the rod side, and a concave curved surface may be provided on the elastic piece portion side of the guide cap (which will be described in other embodiments).

Further, in the present embodiment, the concave curved surface 50 is a concave R curved surface, and the convex curved surface 80 is a convex R curved surface. Alternatively, the concave curved surface and the convex curved surface are not limited to curved surfaces having an R shape, and may be any curved surfaces that can come into contact with each other.

Further, in the present embodiment, the entire inner surface of the rod side concave groove 49 forms the concave curved surface 50. Alternatively, for example, the rod side concave groove may be a concave groove in the shape of a quadrangular frame that opens upward, or a concave groove in which both side surfaces are tapered surfaces expanding upward, and the concave curved surface may be formed on the inner surface (for example, the bottom surface). Further, in the present embodiment, the entire convex portion 79 is a convex portion having a spherical shape, and the convex curved surface 80 is provided on the top portion thereof. Alternatively, for example, the convex portion may be cylindrical, a truncated cone (a cone having a circular base), a truncated pyramid and the like, and a convex curved surface may be provided at the top portion thereof.

Further, in the present embodiment, the convex curved surface 80 is a curved surface that draws a steeper curve than the concave curved surface 50, and the apex 80a of the convex curved surface 80 and the peripheral edge portion thereof within a predetermined range are brought into contact (surface contact) with the bottom 50a of the concave curved surface 50 as the center, and the convex curved surface 80 and the concave curved surface 50 are engaged with each other in a concave-convex manner. Alternatively, for example, the curvature radius of the concave curved surface may be made larger than the curvature radius of the convex curved surface so that the apex of the convex curved surface or the peripheral edge portion thereof is brought into contact with the bottom of the concave curved surface in a state close to point contact, or the curvature radius of the concave curved surface and the curvature radius of the convex curved surface may be made close to each other so that the concave curved surface and the convex curved surface are brought into contact with each other in a state close to concave-convex fitting.

Further, in the present embodiment, the elastic piece portion 77 is disposed at a position away from the rod 40 with respect to the protruding surfaces of the pair of cap side guide portions 78 and 78, and the convex curved surface 80 is also disposed at a position away from the rod 40 with respect to the protruding surfaces of the pair of cap side guide portions 78 and 78. Alternatively, for example, while maintaining a state in which the elastic piece portion is disposed at a position spaced apart from the rod with respect to the protruding surfaces of the pair of cap side guide portions, the convex curved surface and the concave curved surface may be made flush with the protruding surfaces of the cap side guide portions, or the convex curved surface and the concave curved surface may protrude higher than the protruding surfaces of the cap side guide portions (protrude in a direction closer to the rod than the protruding surfaces of the cap side guide portions).

Further, in the present embodiment, when the piston 60 moves in a direction away from the end portion wall 25 of the cylinder 20 (when the piston 60 moves in the damper braking direction F1), a braking force due to the pressure reduction in the first air chamber V1 acts, and when the piston 60 moves in a direction toward the end portion wall 25 of the cylinder 20 (when the piston 60 moves in the damper return direction F2), the braking force is released. Alternatively, contrary to the above configuration, the braking force of the damper may be applied when the piston 60 moves in the direction toward the end portion wall 25 of the cylinder 20, and the braking force of the damper may be released when the piston 60 moves in the direction away from the end portion wall 25 of the cylinder 20.

In the present embodiment, the one member is a fixed body such as an accommodation portion of an instrument panel, and the other member is an openable and closable body such as a glove box or a lid. Alternatively, the present disclosure is not limited thereto as long as the pair of members can approach and separate from each other.

Further, in the present embodiment, the air chamber (the first air chamber V1) is formed in the cylinder 20 on the side of the insertion direction of the piston rod 30 with respect to the seal ring 69. Alternatively, an air chamber may be provided in the cylinder on a side opposite to the insertion direction of the piston rod. For example, an exhaust hole is formed in an end portion wall of the cylinder, and a seal cap capable of opening and closing the exhaust hole is attached to a peripheral edge of the exhaust hole. Further, the guide cap attached to the opening portion at the one end portion of the cylinder has a structure capable of sealing a peripheral edge of the opening portion, and capable of sealing a gap between the insertion hole and the rod inserted through the insertion hole, and a sealed air chamber is provided in the cylinder on the side opposite to the insertion direction of the piston rod. When the piston moves in the direction away from the end portion wall of the cylinder (moves in a direction opposite to the insertion direction of the piston rod), the air chamber is pressurized to exert a braking force of the damper. When the piston moves close to the end portion wall of the cylinder (moves in the insertion direction of the piston rod), the seal cap opens the exhaust hole, the air in the air chamber is exhausted, and the braking force of the damper is released.

### (Operations and Effects)

Next, operations and effects of the damper device 10 configured as described above will be described.

In the damper device 10, the piston 60 is in a stationary state in the cylinder 20 when the one member (fixed body or the like) and the other member (openable and closable body or the like) are close to each other.

When the other member moves away from the one member from the above state (when the openable and closable body opens from the fixed body), the piston 60 moves in the damper braking direction F1 in the cylinder 20, and the rod 40 is pulled out from the opening portion 23 side of the cylinder 20. Then, the pressure in the first air chamber V1 in the cylinder 20 is reduced, and the braking force of the damper is applied to the piston 60. As a result, the other member can be slowly moved relative to the one member (the openable and closable body can be slowly opened from the fixed body).

In addition, when the other member is moved in a direction approaching the one member (when the openable and closable body is closed with respect to the fixed body), the piston 60 moves in the damper return direction F2 in the cylinder 20, and the rod 40 is pushed into the cylinder 20.

Then, a predetermined portion of the seal ring 69 in the peripheral direction is deformed to enter the notch portion 65 formed in the piston 60. Accordingly, the opening 66b of the concave groove 66 is opened, and the air in the first air chamber V1 in the cylinder 20 passes through the annular groove 64 and the concave groove 66, flows out from the opening 66a of the concave groove 66 into the through hole 44, and is disposed in the second air chamber V2. Accordingly, the braking force of the damper acting on the piston 60 is released, and the piston 60 can be returned to an initial position.

The damper device 10 is configured such that the convex portion 79 formed on the elastic piece portion 77 enters and comes into contact with the concave portion formed on the rod 40 between the rod 40 and the elastic piece portion 77. More specifically, the axial movement of the piston rod 30 is guided by the convex curved surface 80 and the concave curved surface 50 into which the convex curved surface 80 enters and comes into contact, which are provided between the rod 40 and the elastic piece portion 77 provided on the guide cap 70.

As a result, when the piston rod 30 moves in the cylinder 20, it is possible to restrict wobbling of the rod 40 in the thickness direction (direction along the long axis A) or the width direction (direction along the short axis B). That is, as shown in FIGS. 11 and 12, the convex curved surface 80 and the concave curved surface 50 are in contact with each other in a state of concave-convex engagement, and when the piston rod 30 moves, the concave curved surface 50 slides on the convex curved surface 80, and the axial movement of the piston rod 30 is guided. Therefore, even if an external force acts on the rod 40, the rod 40 is restricted from deviating in the thickness direction and the width direction, and the piston rod 30 can move smoothly in the axial direction.

As described above, in the damper device 10, the wobbling of the rod 40 in the thickness direction and the width direction when the piston rod 30 moves in the cylinder 20 can be restricted by a simple structure based on the convex curved surface 80 and the concave curved surface 50 without providing a plurality of elastic tongue pieces as in the air damper of Patent Literature 1.

Further, during the assembling of the damper device 10 or during the axial movement of the piston rod 30, the rod 40 can be centered with respect to the guide cap 70 so that the apex 80a of the convex curved surface 80 is positioned at the bottom 50a of the concave curved surface 50. That is, when the convex curved surface 80 comes into contact with a portion other than the bottom 50a on an inner peripheral surface of the concave curved surface 50, the concave curved surface 50 slides on the convex curved surface 80, and the rod 40 can be centered with respect to the guide cap 70 such that the apex 80a of the convex curved surface 80 is positioned at the bottom 50a of the concave curved surface 50. As a result, it is possible to improve the assembly work of the piston rod 30 and the guide cap 70, and it is possible to makes it easier to restrict the wobbling of the rod 40 in the thickness direction and the width direction during the axial movement of the piston rod 30.

In the present embodiment, as shown in FIG. 12, the curvature radius R2 of the convex curved surface 80 is formed to be smaller than the curvature radius R1 of the concave curved surface 50, so that centering the rod 40 with respect to the guide cap 70, that is, positioning the apex 80a of the convex curved surface 80 at the bottom 50a of the concave curved surface 50 can be more easily performed.

Further, since the guide structure as described above is provided in a portion of the guide cap 70 inserted into the cylinder 20 (here, the convex curved surface 80 forming a part of the guide structure is provided in the elastic piece portion 77 provided in the insertion wall portion 71), it is possible to suppress an increase in size of the guide cap 70.

Further, in the present embodiment, the convex portion 79 protrudes from the elastic piece portion 77, the convex curved surface 80 is provided on the top portion of the convex portion 79, the rod side concave groove 49 forming the concave portion extends along the axial direction of the rod 40, and the concave curved surface 50 is provided on the inner surface of the rod side concave groove 49. As shown in FIG. 12, when the curvature radius of the concave curved surface 50 with respect to the axial center C1 of the rod 40 is R1 and the curvature radius of the convex curved surface 80 with respect to the axial center C3 of the guide cap 70 is R2, R1>R2 is satisfied.

According to the above aspect, the convex portion 79 is provided to protrude from the elastic piece portion 77 to be elastically deformed, the convex curved surface 80 is provided on the top portion of the convex portion 79, the convex curved surface 80 enters and comes into contact with the concave curved surface 50 on the inner surface of the rod side concave groove 49, and the curvature radius R1 and R2 of the concave curved surface 50 and the convex curved surface 80 are set as described above. Therefore, the rod 40 can be easily centered with respect to the guide cap 70, and the piston rod 30 can be easily held in a stable position. In addition, even if the piston rod 30 is inclined during the axial movement of the piston rod 30, it is possible to prevent an increase in sliding resistance and to make the piston rod 30 less likely to rattle.

Further, as shown in FIGS. 11 and 12, in the present embodiment, the pair of cap side guide portions 78 and 78 protruding to face the surface of the rod 40 in the direction along the long axis A are provided on both sides of the elastic piece portion 77, the elastic piece portion 77 is disposed at a position away from the rod 40 with respect to the protruding surfaces of the pair of cap side guide portions 78 and 78, and one of the convex curved surface and the concave curved surface is provided on the elastic piece portion 77 (here, the convex curved surface 80 is provided). The rod 40 has the pair of rod side guide portions 47 and 47 extending in the axial direction and arranged so as to face the pair of cap side guide portions 78 and 78 provided on the guide cap 70, and the protruding portion 48 that protrudes toward the guide cap 70 with respect to the protruding surfaces of the pair of rod side guide portions 47 and 47, enters between the pair of cap side guide portions 78 and 78, and extends in the axial direction. The other of the convex curved surface and the concave curved surface is provided on the protruding portion 48 (here, the concave curved surface 50 is provided).

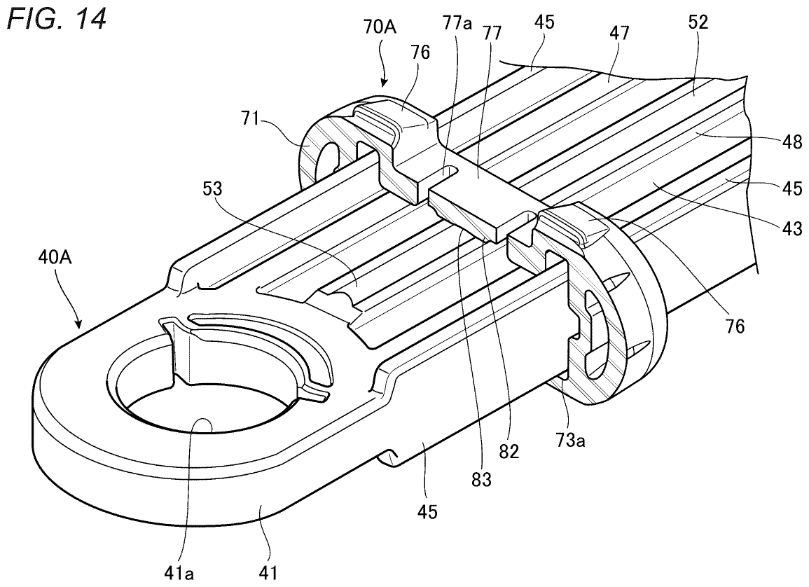

With the configuration described above, when the rod 40 is inserted into and assembled to the insertion hole 73 of the guide cap 70, it is possible to prevent the rod 40 from getting caught by the convex curved surface 80 provided on the elastic piece portion 77 of the guide cap 70, and the workability of assembling the damper device 10 can be further improved. Further, as in a second embodiment shown in FIGS. 14 to 16 to be described later, in a case where the concave curved surface 83 is provided in the elastic piece portion 77, it is possible to prevent the rod 40 from getting caught on a side edge portion, a corner portion, or the like of a convex base portion 82 provided with a concave curved surface 83, and the workability of assembling the damper device 10 can also be further improved in this case. In the present embodiment, the outer surface of the one end portion 41 of the rod 40 and the outer surfaces of the rod side guide portions 47, 47 are at the same height (on the same plane). Therefore, if the elastic piece portion 77 and each cap side guide portion 78 are at the same height (on the same plane), and the convex curved surface 80 protrudes beyond the protruding surface of each cap side guide portion 78 (when being close to the rod 40), the one end portion 41 of the rod 40 is likely to be caught by the convex curved surface 80, and the workability of assembling the damper device 10 is deteriorated.

In addition, in the present embodiment, the ribs 45 that are standing in the direction orthogonal to the surface 43a along the long axis A and extending in the axial direction are provided from both sides of the surfaces 43a and 43a of the rod 40 along the long axis A, the portion of the rib 45 that is located on the piston 60 side is provided with the standing portion 45a that stands higher than the other portions (see FIG. 5), and the standing portion 45a can come into contact with the inner peripheral surface of both end portions of the insertion hole 73 of the guide cap 70 (see FIG. 13). The guide cap 70 is formed with the insertion grooves 73a into which the ribs 45 of the rod 40 are inserted at both end portions of the insertion hole 73, and the engaging claw 76 that is formed to be bendable and deformable and engages with the engaging hole 23a provided in the opening portion 23 of the cylinder 20 from an inner periphery thereof, and the engaging claw 76 is disposed at the position corresponding to the outside of the standing portion 45a of the rib 45.

With the configuration described above, when the piston rod 30 is pulled from the cylinder 20 to the maximum limit, as shown in FIG. 13, the standing portion 45a of the rib 45 of the rod 40 is positioned inside the engaging claw 76 of the guide cap 70, so that it is possible to prevent the guide cap 70 from coming off the opening portion 23 of the cylinder 20 by restricting the bending of the engaging claw 76 toward the inside of the cylinder. Further, since the rib 45 of the rod 40 is inserted into the insertion groove 73a of the guide cap 70, the inclination of the piston rod 30 can be suppressed.

Further, in the present embodiment, the groove 51 extending along the axial direction is formed on the surface of the rod 40 along the long axis A and between the rib 45 and the rod side guide portion 47 (see FIG. 11).

Since the groove 51 is formed as described above, even when the piston rod 30 is inclined and comes into contact with the inner periphery of the insertion wall portion 71 of the guide cap 70, a contact area can be reduced by the groove 51, and it is possible to suppress an increase in sliding resistance when the piston rod 30 is inclined.

### Damper Device According to Second Embodiment

A damper device according to the second embodiment of the present invention is shown in FIGS. 14 to 16. The same reference signs are given to substantially the same parts as those in the above-described embodiments, and description thereof will be omitted.

In the damper device according to the present embodiment, a convex portion and a convex curved surface 53 are formed on a rod 40A side, and a concave portion and the concave curved surface 83 are formed on a guide cap 70A side. Further, the rod 40A is provided with a rod side protrusion 52 extending along an axial direction thereof and forming a “convex portion” according to the present invention, the convex curved surface 53 is provided on a top portion of the rod side protrusion 52, the convex base portion 82 is provided in a protruding manner on the elastic piece portion 77 of the guide cap 70A, and the concave curved surface 83 is provided on a top portion of the convex base portion 82.

More specifically, as shown in FIG. 14, the rod side protrusion 52 having a protruding shape further extends along the axial direction of the rod 40A from the outer surface (the surface facing the inner peripheral surface of the cylinder 20) of the protruding portion 48 provided on the rod 40A. The convex curved surface 53 forming a convex R curved surface is provided on the top portion of the rod side protrusion 52 forming the convex portion, and the convex curved surface 53 extends along the axial direction of the rod 40A.

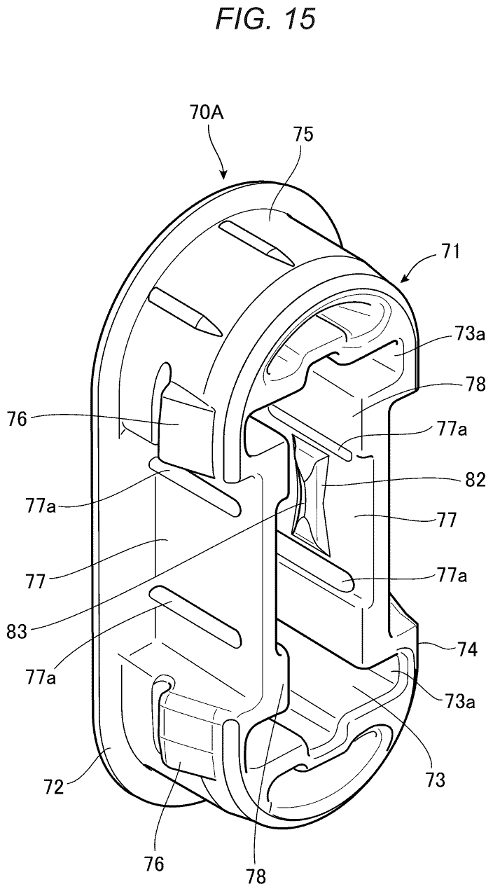

On the other hand, as shown in FIG. 15, a convex base portion 82 having a bottom portion with a substantially rectangular shape protrudes from the inner surface of each elastic piece portion 77 of the guide cap 70A and forms a substantially quadrangular pyramid shape that gradually protrudes higher toward the elastic piece portion 77 on another side. The concave curved surface 83 having a concave R curved surface is provided on a top portion of the convex base portion 82.

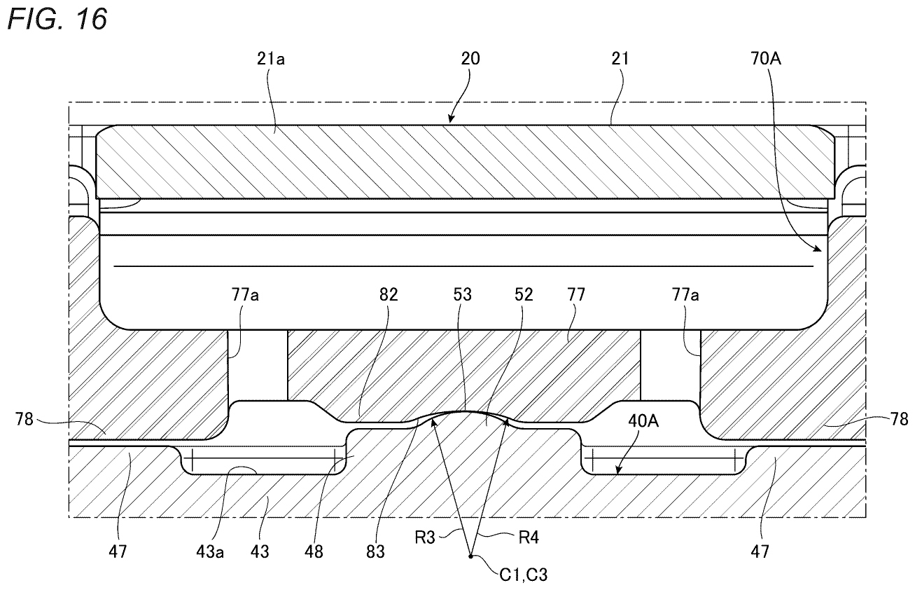

As shown in FIG. 16, when a curvature radius of the convex curved surface 53 with respect to the axial center C1 of the rod 40A is R3 and a curvature radius of the concave curved surface 83 with respect to the axial center C3 of the guide cap 70A is R4, R3<R4 is satisfied.

As shown in FIG. 16, the convex curved surface 53 on the rod 40A side enters and comes into contact with the concave curved surface 83 on the guide cap 70A side.

In the present embodiment, an axial length of the convex base portion 82 provided on the elastic piece portion 77 of the guide cap 70A can be made shorter than that of the rod side protrusion 52 provided on the rod 40A, so that during the axial movement of the piston rod 30, even if the piston rod 30 is inclined, it is possible to prevent an increase in sliding resistance and to make the piston rod 30 less likely to rattle. Further, the curvature radius R3 and the curvature radius R4 of the convex curved surface 53 and the concave curved surface 83 are set as described above, so that the rod 40A is easily centered with respect to the guide cap 70A, and the piston rod 30 is easily held in a stable position.

### Damper Device According to Third Embodiment

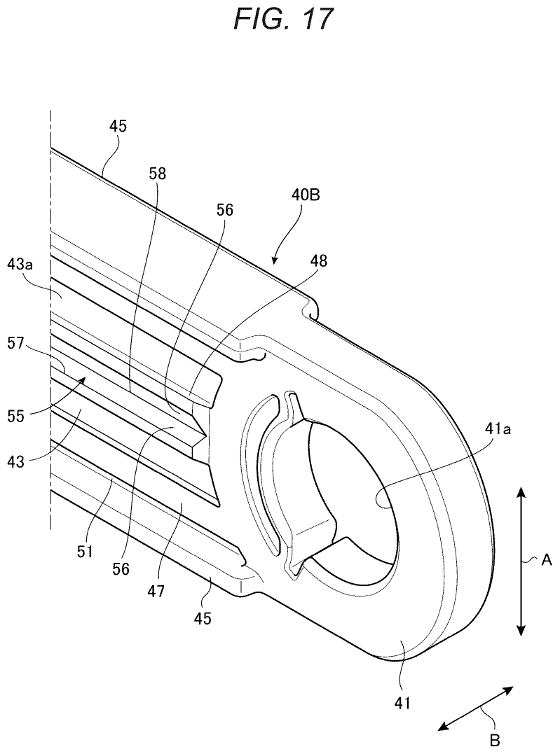

A damper device according to a third embodiment of the present invention is shown in FIGS. 17 to 19. The same reference signs are given to substantially the same parts as those in the above-described embodiments, and description thereof will be omitted.

In the damper device according to the present embodiment, a concave portion 55 is formed in a rod 40B, and the convex portion 79 is formed in a guide cap 70B.

Further, inclined surfaces 56 and 56 extending from an opening 57 to a bottom portion 58 of the concave portion 55 are provided on inner surfaces on both sides of the concave portion 55. The inclined surfaces 56 and 56 in the present embodiment have a shape that becomes narrower from the opening 57 toward the bottom portion 58 of the concave portion 55. The convex portion 79 comes into contact with the inclined surfaces 56 and 56 of the concave portion 55 at two positions. Of contact portions between the convex portion 79 and the inclined surfaces 56, 56 of the concave portion 55, the one on the convex portion 79 side is a convex curved surface forming a curved surface.

More specifically, the concave portion 55 in the present embodiment is formed to a predetermined depth from a maximum protruding portion (a portion farthest from the surface 43a in the thickness direction of the shaft portion 43) of the protruding portion 48 that protrudes from the shaft portion 43 of the rod 40B, and extends in the axial direction of the rod 40B.

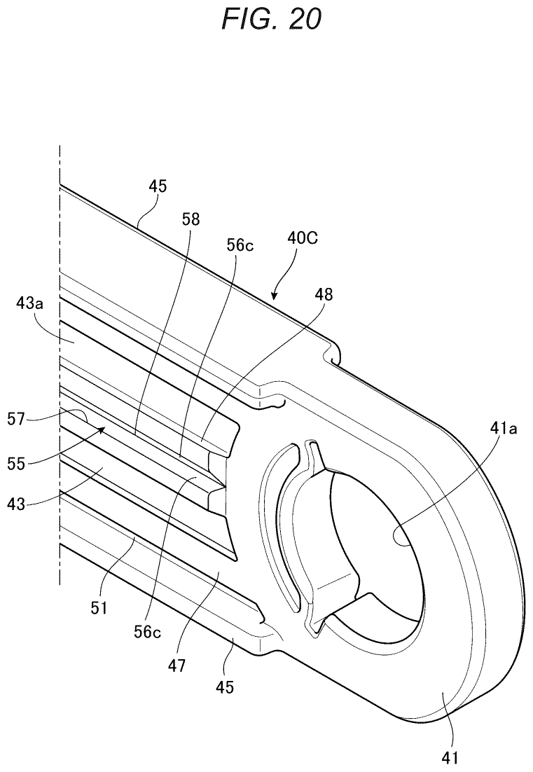

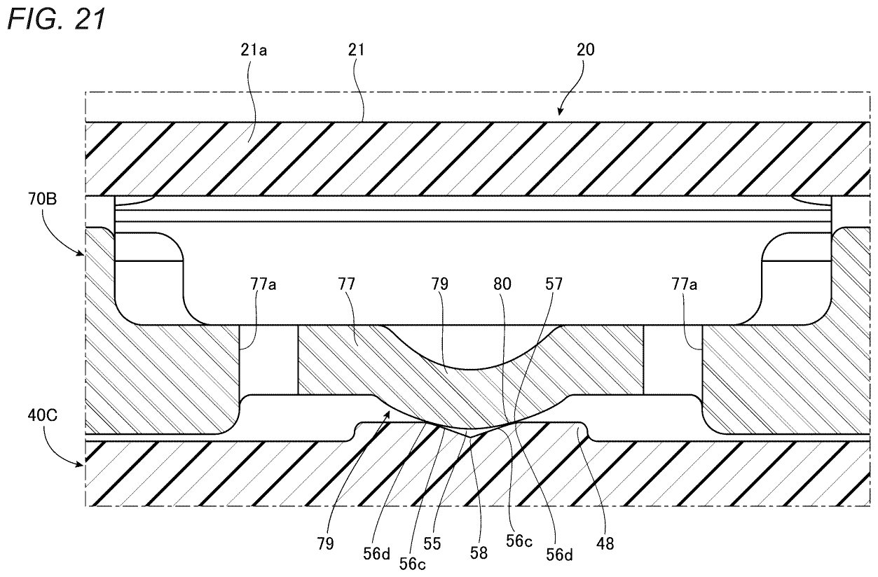

Both sides of the concave portion 55 mean both sides along the width direction of the rod 40B (both sides in the direction along the long axis A of the rod 40B) (the same applies to a fourth embodiment shown in FIGS. 20 and 21).

The inclined surface 56, 56 each having a tapered surface shape whose width gradually decreases from the opening 57 (an opening portion facing the bottom portion 58, here, an opening portion positioned on the maximum protruding surface of the protruding portion 48) of the concave portion 55 toward the bottom portion 58 (a side opposite to the opening 57, a side toward an inner side in the thickness direction of the shaft portion 43 of the rod 40B) of the concave portion 55 are provided on the inner surfaces on both sides of the concave portion 55. The pair of inclined surfaces 56, 56 are narrowest at the bottom portion 58 (see FIG. 17).

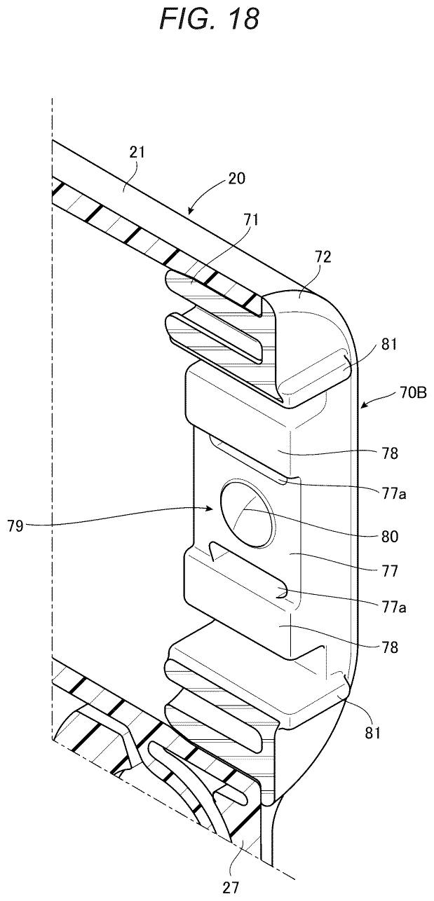

On the other hand, as shown in FIG. 18, the convex portion 79 has the same shape and structure as those of the first embodiment, and has the convex curved surface 80 forming a curved surface.

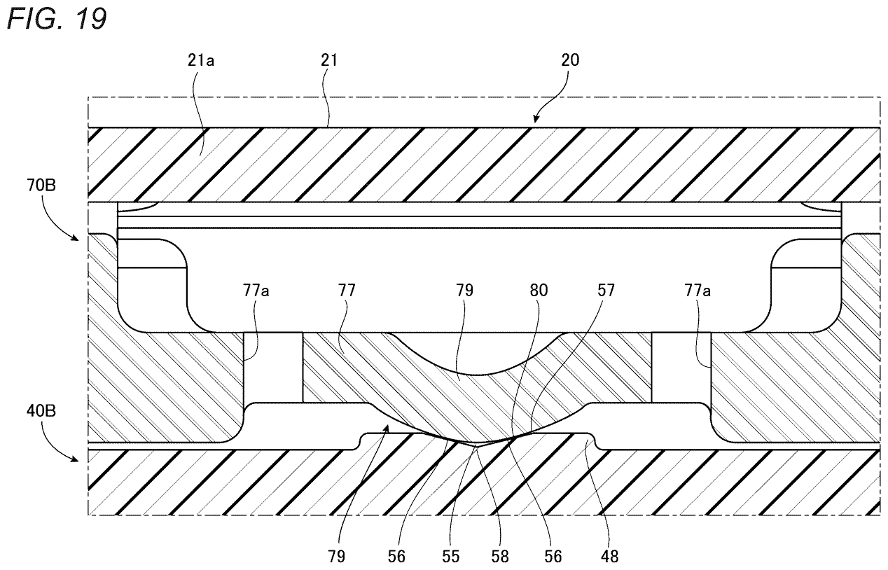

As shown in FIG. 19, the convex curved surface 80 of the convex portion 79 inserted into the concave portion 55 comes into contact with the pair of inclined surfaces 56, 56 of the concave portion 55 (a structure in which the convex curved surface and the tapered surface come into contact with each other at two positions).

In the present embodiment, as described above, since the convex curved surface 80 of the convex portion 79 is in contact with the inclined surfaces 56 and 56 of the concave portion 55 at two positions, so that it is possible to more appropriately restrict the wobbling of the rod 40B in the thickness direction and the width direction when the piston rod 30 moves in the cylinder 20.

The inclined surfaces 56, 56 in the present embodiment are tapered over the entire range from the opening 57 to the bottom portion 58 of the concave portion 55. Alternatively, the tapered surface may be provided only in a predetermined range from the opening to the bottom portion of the concave portion, and may have any shape that allows the convex portion to come into contact with the tapered surface at two positions.

Further, the inclined surface 56 of the present embodiment has a tapered surface shape, that is, a linear shape. Alternatively, the “inclined surface” in the present invention may have a shape that gradually narrows from the opening toward the bottom portion of the concave portion while drawing a curved surface shape such as a convex curved surface or a concave curved surface (which will be described in fourth and sixth embodiments described later). That is, the “inclined surface” of the present invention includes a curved surface.

### Damper Device According to Fourth Embodiment

A damper device according to the fourth embodiment of the present invention is shown in FIGS. 20 and 21. The same reference signs are given to substantially the same parts as those in the above-described embodiments, and description thereof will be omitted.

The damper device according to the present embodiment basically has the same shape as that of the third embodiment shown in FIGS. 17 to 19, but the shape of the concave portion 55 is different. The concave portion 55 is formed in a rod 40C, and the convex portion 79 is formed in the guide cap 70B.

Inclined surfaces 56c, 56c are provided on the inner surfaces on both sides of the concave portion 55 in the present embodiment, and the pair of inclined surfaces 56c, 56c are narrowest at the bottom portion 58 of the concave portion 55. Further, the vicinity of the opening 57 in the inclined surfaces 56c, 56c is formed with convex curved surfaces 56d, 56d which draw a gentle R shape and become convex toward the guide cap 70B.

In the case of the present embodiment, as shown in FIG. 21, the convex curved surface 80 of the convex portion 79 inserted into the concave portion 55 comes into contact with each of the convex curved surfaces 56d and 56d with the R shape of the pair of inclined surfaces 56c and 56c provided on the inner surfaces on both sides of the concave portion 55 (a structure in which the convex curved surfaces come in contact with each other at two positions). Since the convex curved surface 80 of the convex portion 79 comes into contact with the convex curved surfaces 56d and 56d of the inclined surfaces 56c and 56c of the concave portion 55 at two positions, the same operation and effect as those of the third embodiment can be obtained.

### Damper Device According to Fifth Embodiment

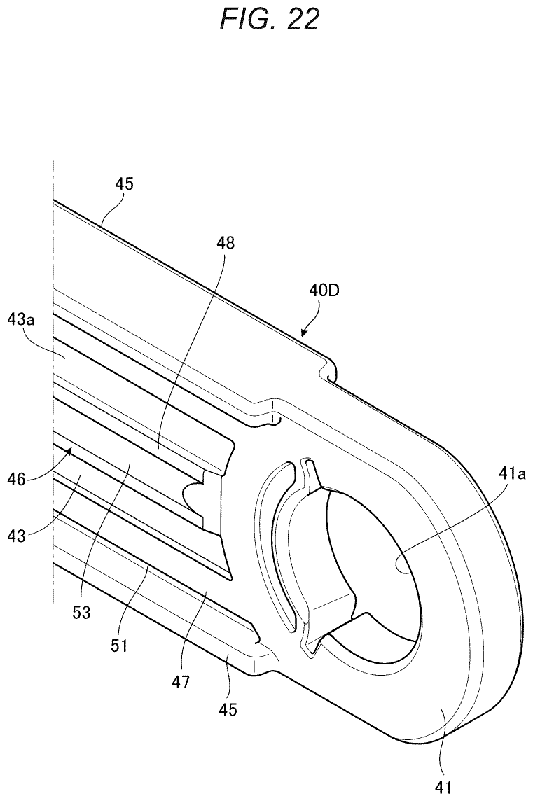

A damper device according to a fifth embodiment of the present invention is shown in FIGS. 22 to 24. The same reference signs are given to substantially the same parts as those in the above-described embodiments, and description thereof will be omitted.

In the damper device according to the present embodiment, a convex portion 46 is formed in a rod 40D, and a concave portion 85 is formed in a guide cap 70D.

The concave portion 85 is provided with inclined surfaces 87, 87 on inner surfaces on both sides. The inclined surfaces 87, 87 become narrower from an opening 57 toward a bottom portion 89 of the concave portion 85. The convex portion 46 comes into contact with the inclined surfaces 87, 87 of the concave portion 85 at two positions. Of contact portions between the convex portion 46 and the inclined surfaces 87, 87 of the concave portion 85, the one on the convex portion 46 side is provided with the convex curved surface 53 forming a curved surface.

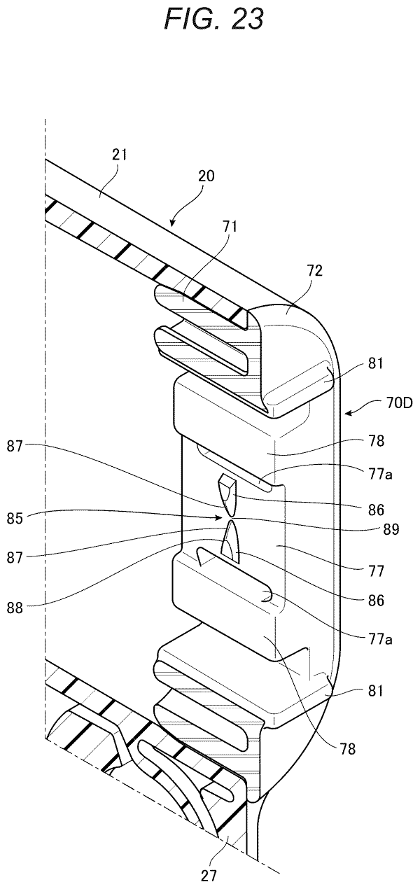

As shown in FIG. 23, in the case of the present embodiment, a pair of convex base portions 86 and 86 are provided to protrude from the inner surface of the elastic piece portion 77 of the guide cap 70D, and the concave portion 85 is formed between the pair of convex base portions 86 and 86 at a predetermined depth from a maximum protruding portion (a portion farthest from the inner surface of the elastic piece portion 77) of the convex base portion 86.

More specifically, the inclined surfaces 87, 87 each having a tapered surface shape whose width gradually decreases from an opening 88 of the concave portion 85 (the opening portion facing the bottom portion 89, the opening portion positioned at a maximum protruding surface of the convex base portion 86) toward the bottom portion 89 of the concave portion 85 (the portion on a side opposite to the opening 88 and at the same height as the inner surface of the elastic piece portion 77) are provided on the inner surfaces (two opposing surfaces of the pair of convex base portions 86, 86) on both sides of the concave portion 85. The pair of inclined surfaces 87, 87 are narrowest at the bottom portion 89 of the concave portion 85.

The predetermined convex base portion 86 also has an inclined surface 87 formed on an outer peripheral surface extending from the inclined surface 87 provided on an opposing surface of the convex base portion 86 on another side toward a surface opposite to the opposing surface (base end surface).

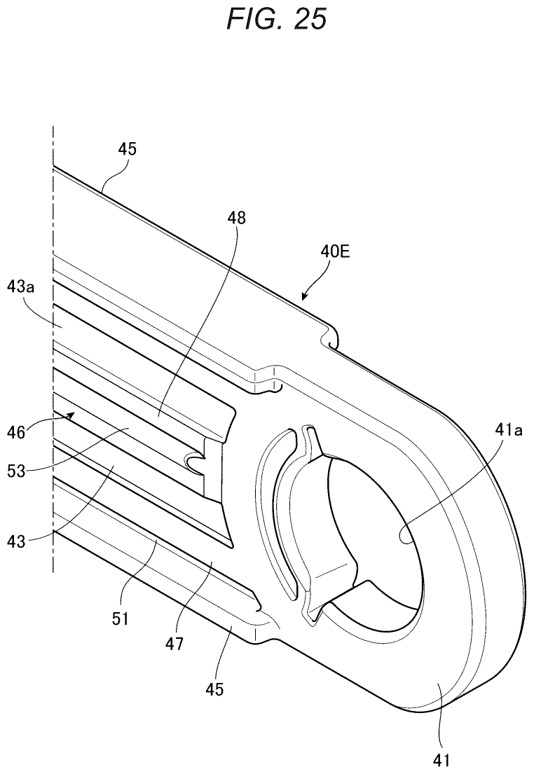

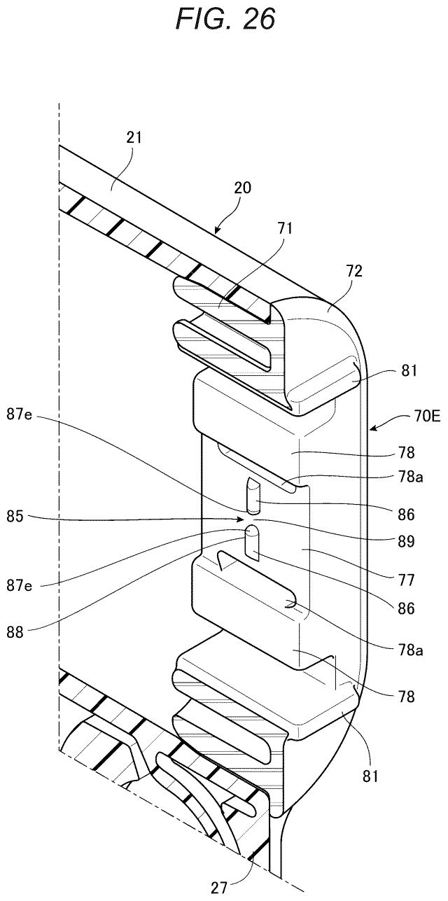

Both sides of the concave portion 85 mean both sides along the width direction of the guide cap 70D (the same applies to the sixth embodiment shown in FIGS. 25 to 27).

On the other hand, as shown in FIG. 22, similarly to the second embodiment, the convex portion 46 protrudes from the outer surface of the protruding portion 48, forms a protrusion extending along the axial direction of the rod 40D, and has the convex curved surface 53.

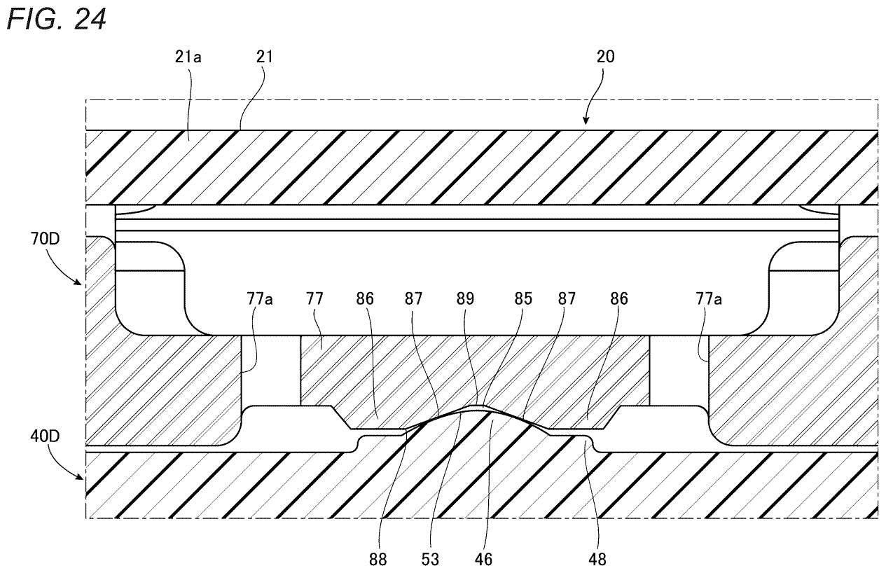

As shown in FIG. 24, the convex curved surface 53 of the convex portion 46 inserted into the concave portion 85 comes into contact with the pair of inclined surfaces 87, 87 of the concave portion 85 (a structure in which the convex curved surface and the tapered surface come into contact with each other at two positions). That is, since the convex curved surface 53 of the convex portion 46 comes into contact with the inclined surfaces 87, 87 of the concave portion 85 at two positions, the same operation and effect as those of the third and fourth embodiments can be obtained.

### Damper Device According to Sixth Embodiment

A damper device according to a sixth embodiment of the present invention is shown in FIGS. 25 to 27. The same reference signs are given to substantially the same parts as those in the above-described embodiments, and description thereof will be omitted.

The damper device according to the present embodiment basically has the same shape as that of the fifth embodiment shown in FIGS. 22 to 24, but the shape of the concave portion 85 is different. The convex portion 46 having the convex curved surface 53 is formed on a rod 40E, and the concave portion 85 is formed on a guide cap 70E. The convex portion 46 is formed to be narrower than that of the fifth embodiment.

In the case of the present embodiment, inclined surfaces 87e, 87e, which are convex curved surfaces convex toward the guide cap 70B while drawing an R shape as a whole, are provided on opposing surfaces of the pair of convex base portions 86, 86 (forming inner surfaces on both side of the concave portion 85) protruding from the inner surface of the elastic piece portion 77 of the guide cap 70E, that is, on the inner surfaces on both sides of the concave portion 85. The pair of inclined surfaces 87e, 87e have the narrowest width in the bottom portion 89 of the concave portion 85. Further, convex curved surfaces 87f, 87f are provided in the vicinity of the opening 88 of the inclined surfaces 87e, 87e.

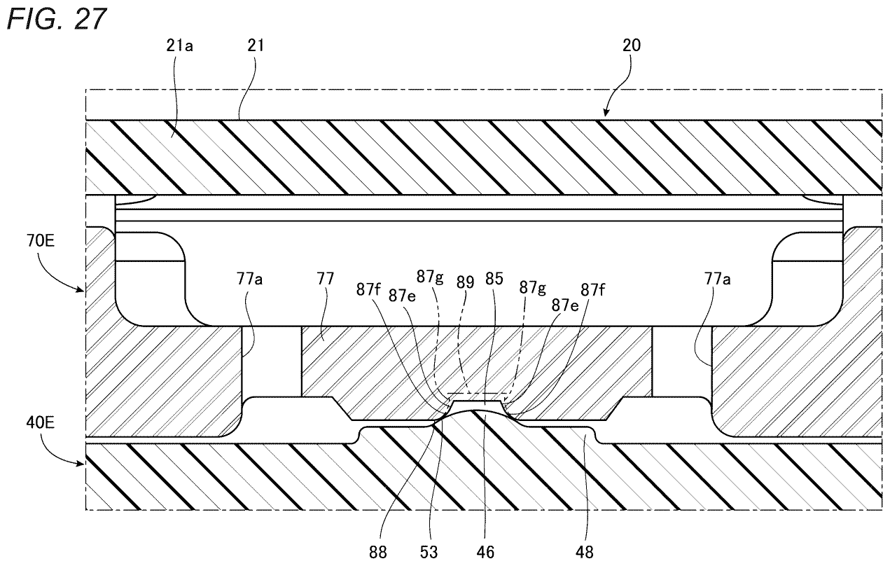

It can be said that the inner surfaces on both side of the concave portion 85 are provided with the inclined surfaces 87e and 87e extending from the opening 88 toward the bottom portion 89 of the concave portion 85, and that the inclined surfaces 87e and 87e are shaped to be narrower from the opening 88 toward the bottom portion 89 of the concave portion 85. In addition, the inclined surface may have a shape in which the bottom portion 89 is wider than a minimum distance (a length between apexes of the inclined surfaces 87g, 87g disposed to face each other, which protrude to another side by the maximum limit), like the inclined surfaces 87g, 87g indicated by two-dot chain line in FIG. 27.

As shown in FIG. 27, the convex curved surface 53 of the convex portion 46 inserted into the concave portion 85 comes into contact with the R-shaped convex curved surfaces 87f, 87f of the pair of inclined surfaces 87e, 87e of the concave portion 85 (a structure in which the convex curved surfaces come into contact with each other at two positions). As described above, since the convex curved surface 53 of the convex portion 46 comes into contact with the convex curved surfaces 87f and 87f of the inclined surfaces 87e and 87e of the concave portion 85 at two positions, the same operation and effect as those of the third to fifth embodiments can be obtained.

### (Modifications of Damper Device)

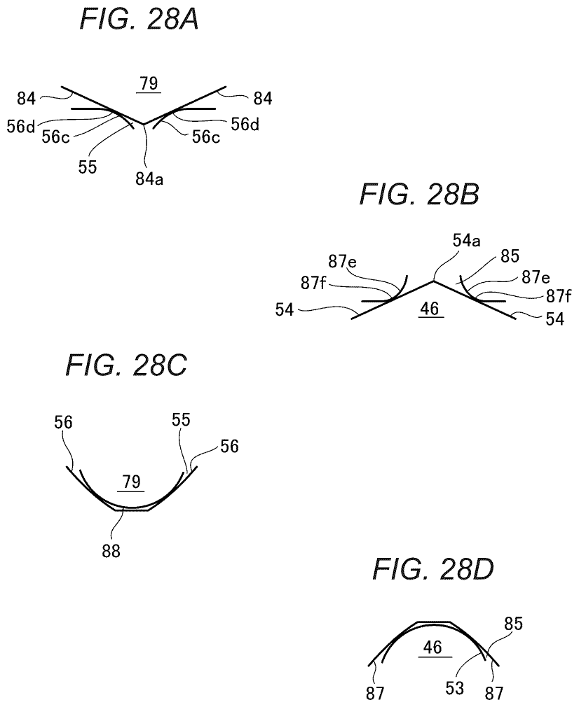

(a) to (d) of FIG. 28 show modifications of the damper device according to the third to sixth embodiments of the present invention.

A first modification shown in (a) of FIG. 28 has substantially the same shape as that of the fourth embodiment shown in FIGS. 20 and 21, but the shape of the convex portion 79 provided on the guide cap side is different. That is, the convex portion 79 has an outer surface provided with inclined surfaces 84 and 84 each having a tapered surface shape whose diameter gradually decreases toward a top portion 84a.

The pair of inclined surfaces 84, 84 each having a tapered surface shape of the convex portion 79 inserted into the concave portion 55 come into contact with the R-shaped convex curved surfaces 56d, 56d of the pair of inclined surfaces 56c, 56c in the concave portion 55, respectively (a structure in which the convex curved surfaces and the tapered surfaces come into contact with each other at two positions).

A second modification shown in (b) of FIG. 28 has substantially the same shape as that of the sixth embodiment shown in FIGS. 25 to 27, but the shape of the convex portion 46 provided on the rod side is different. That is, the convex portion 46 has an outer surface provided with inclined surfaces 54 and 54 each having a tapered surface shape whose diameter gradually decreases toward a top portion 54a.

The pair of inclined surfaces 54, 54 each having a tapered surface shape of the convex portion 46 inserted into the concave portion 85 come into contact with the R-shaped convex curved surfaces 87f, 87f of the pair of inclined surfaces 87e, 87e in the concave portion 85, respectively (a structure in which the convex curved surfaces come into contact with the tapered surfaces at two positions).

A third modification shown in (c) of FIG. 28 has substantially the same shape as that of the third embodiment shown in FIGS. 17 to 19, but the shape of the concave portion 55 provided on the rod side is different. That is, the inclined surfaces 56, 56 on the inner surfaces on both side of the concave portion 55 form a concave curved surface shape.

The convex curved surface 80 of the convex portion 79 inserted into the concave portion 55 comes into contact with the pair of inclined surfaces 56, 56 each having the concave curved surface shape of the concave portion 55 (a structure in which the convex curved surface and the concave curved surface come into contact with each other at two positions).

A fourth modification shown in (d) of FIG. 28 has substantially the same shape as that of the fifth embodiment shown in FIGS. 22 and 24, but the shape of the concave portion 85 provided on the guide cap side is different. That is, the inclined surfaces 87, 87 on the inner surfaces on both side of the concave portion 85 form a concave curved surface shape.

The convex curved surface 53 of the convex portion 46 inserted into the concave portion 85 comes into contact with the pair of inclined surfaces 87, 87 each having the concave curved surface shape of the concave portion 85 (a structure in which the convex curved surface and the concave curved surface come into contact with each other at two positions).

The present invention is not limited to the embodiments described above, various modifications can be made within the scope of the gist of the present invention, and such embodiments are also included in the scope of the present invention.

### REFERENCE SIGNS LIST

10: damper device
20: cylinder
21: wall portion
23: opening portion
23a: engaging hole
30: piston rod
40, 40A, 40B, 40C, 40D, 40E: rod
45: rib
45a: standing portion
46: convex portion
47: rod side guide portion
49: rod side concave groove
50: concave curved surface
52: rod side protrusion
53: convex curved surface
55: concave portion
56, 56c: inclined surface
57: opening
58: bottom portion
60: piston
70, 70A, 70B, 70C, 70D, 70E: guide cap
71: insertion wall portion
73: insertion hole
73a: insertion groove
76: engaging claw
77: elastic piece portion
78: cap side guide portion
79: convex portion
80: convex curved surface
82: convex base portion
83; concave curved surface
85: concave portion
86: convex base portion
87: inclined surface
88: opening
89: bottom portion

1. A damper device configured to be attached between a pair of members that are configured to approach and separate from each other, and configured to apply a braking force when the pair of members approach or separate from each other, the damper device comprising:
a cylinder having an opening portion at one end portion;
a piston rod movably inserted into the cylinder through the opening portion; and
a guide cap attached to the opening portion of the cylinder,
wherein the piston rod includes a rod and a piston coupled to the rod,
wherein the cylinder has a tubular wall portion, and a cross section of the wall portion orthogonal to a moving direction of the piston has a shape having a long axis and a short axis,
wherein the piston is shaped to have a long axis and a short axis to fit with an inner periphery of the wall portion of the cylinder,
wherein when viewed from an axial direction, the rod has a long axis along a long axis direction of the piston and a short axis orthogonal to the long axis, and has a plate shape extending by a predetermined length,
wherein the guide cap includes an insertion wall portion inserted into the opening portion of the cylinder, an insertion hole into which the rod is inserted, and an elastically deformable elastic piece portion provided in a portion of the insertion wall portion facing the rod,
wherein between the rod and the elastic piece portion, one of the rod and the elastic piece portion is formed with a convex portion, and another of the rod and the elastic piece portion is formed with a concave portion that allows the convex portion to enter and come into contact therewith,
wherein the convex portion or the concave portion provided on the rod extends in the axial direction and is configured to guide an axial movement of the piston rod, and
wherein, of contact portions between the convex portion and the concave portion, at least one contact portion on a side of the convex portion and on a side of the concave portion is a curved surface,
wherein the convex portion has a convex curved surface that forms the curved surface, and the concave portion has a concave curved surface that forms the curved surface, and the convex curved surface and the concave curved surface are configured to come into contact with each other,
wherein the convex portion protrudes from the elastic piece portion, and the convex curved surface is provided on a top portion of the convex portion,
wherein a rod side concave groove that forms the concave portion extends along the axial direction of the rod, the concave curved surface is provided on an inner surface of the rod side concave groove, and
wherein when a curvature radius of the concave curved surface with respect to an axial center of the rod is R1 and a curvature radius of the convex curved surface with respect to an axial center of the guide cap is R2, R1>R2 is satisfied.

2. (canceled)

3. (canceled)

4. A damper device configured to be attached between a pair of members that are configured to approach and separate from each other, and configured to apply a braking force when the pair of members approach or separate from each other, the damper device comprising:
a cylinder having an opening portion at one end portion;
a piston rod movably inserted into the cylinder through the opening portion; and
a guide cap attached to the opening portion of the cylinder,
wherein the piston rod includes a rod and a piston coupled to the rod,
wherein the cylinder has a tubular wall portion, and a cross section of the wall portion orthogonal to a moving direction of the piston has a shape having a long axis and a short axis,
wherein the piston is shaped to have a long axis and a short axis to fit with an inner periphery of the wall portion of the cylinder,
wherein when viewed from an axial direction, the rod has a long axis along a long axis direction of the piston and a short axis orthogonal to the long axis, and has a plate shape extending by a predetermined length,
wherein the guide cap includes an insertion wall portion inserted into the opening portion of the cylinder, an insertion hole into which the rod is inserted, and an elastically deformable elastic piece portion provided in a portion of the insertion wall portion facing the rod,
wherein between the rod and the elastic piece portion, one of the rod and the elastic piece portion is formed with a convex portion, and another of the rod and the elastic piece portion is formed with a concave portion that allows the convex portion to enter and come into contact therewith,
wherein the convex portion or the concave portion provided on the rod extends in the axial direction and is configured to guide an axial movement of the piston rod, and
wherein, of contact portions between the convex portion and the concave portion, at least one contact portion on a side of the convex portion and on a side of the concave portion is a curved surface,
wherein the convex portion has a convex curved surface that forms the curved surface, and the concave portion has a concave curved surface that forms the curved surface, and the convex curved surface and the concave curved surface are configured to come into contact with each other,
wherein a rod side protrusion that forms the convex portion extends along the axial direction of the rod, and the convex curved surface is provided on a top portion of the rod side protrusion,
wherein a convex base portion protrudes from the elastic piece portion, and the concave curved surface is provided at a top portion of the convex base portion, and
wherein when a curvature radius of the convex curved surface with respect to an axial center of the rod is R3 and a curvature radius of the concave curved surface with respect to an axial center of the guide cap is R4, R3<R4 is satisfied.

5. The damper device according to claim 1,
wherein a pair of cap side guide portions protruding to face a surface of the rod in a direction along the long axis are provided on both sides of the elastic piece portion,
wherein the elastic piece portion is disposed at a position away from the rod with respect to protruding surfaces of the pair of cap side guide portions, and one of the convex curved surface and the concave curved surface is provided on the elastic piece portion,
wherein the rod includes a pair of rod side guide portions disposed to face the pair of cap side guide portions and extending in the axial direction, and a protruding portion protruding toward the guide cap with respect to protruding surfaces of the pair of rod side guide portions, entering between the pair of cap side guide portions, and extending in the axial direction, and
wherein another of the convex curved surface and the concave curved surface is provided on the protruding portion.

6. The damper device according to claim 1,
wherein from both sides of a surface along the long axis of the rod, ribs standing in a direction orthogonal to the surface along the long axis and extending in the axial direction are provided, a portion of the rib positioned on a side of the piston is provided with a standing portion that stands higher than other portions, and the standing portion is configured to come into contact with inner peripheral surfaces of both end portions of the insertion hole of the guide cap, and
wherein the guide cap is formed with insertion grooves into which the ribs of the rod are inserted at both end portions of the insertion hole, and an engaging claw is formed to be deflectable and deformable and to be engaged with an engaging hole provided in the opening portion of the cylinder from an inner periphery thereof, and the engaging claw is disposed at a position corresponding to outside of the standing portion.

7. The damper device according to claim 5,
wherein from both sides of a surface along the long axis of the rod, ribs standing in a direction orthogonal to the surface along the long axis and extending in the axial direction are provided, and
wherein a groove extending in the axial direction is formed between each of the ribs and the rod side guide portion on the surface along the long axis of the rod.

8. (canceled)

9. A damper device configured to be attached between a pair of members that are configured to approach and separate from each other, and configured to apply a braking force when the pair of members approach or separate from each other, the damper device comprising:
a cylinder having an opening portion at one end portion;
a piston rod movably inserted into the cylinder through the opening portion; and
a guide cap attached to the opening portion of the cylinder,
wherein the piston rod includes a rod and a piston coupled to the rod,
wherein the cylinder has a tubular wall portion, and a cross section of the wall portion orthogonal to a moving direction of the piston has a shape having a long axis and a short axis,
wherein the piston is shaped to have a long axis and a short axis to fit with an inner periphery of the wall portion of the cylinder,
wherein when viewed from an axial direction, the rod has a long axis along a long axis direction of the piston and a short axis orthogonal to the long axis, and has a plate shape extending by a predetermined length,
wherein the guide cap includes an insertion wall portion inserted into the opening portion of the cylinder, an insertion hole into which the rod is inserted, and an elastically deformable elastic piece portion provided in a portion of the insertion wall portion facing the rod,
wherein between the rod and the elastic piece portion, one of the rod and the elastic piece portion is formed with a convex portion, and another of the rod and the elastic piece portion is formed with a concave portion that allows the convex portion to enter and come into contact therewith,
wherein the convex portion or the concave portion provided on the rod extends in the axial direction and is configured to guide an axial movement of the piston rod, and
wherein, of contact portions between the convex portion and the concave portion, at least one contact portion on a side of the convex portion and on a side of the concave portion is a curved surface,
wherein inner surfaces on both sides of the concave portion are provided with inclined surfaces from an opening to a bottom portion of the concave portion,
wherein the convex portion is configured to come into contact with the inclined surfaces of the concave portion at two positions, and
wherein, of contact portions between the convex portion and the inclined surfaces of the concave portion, at least one contact portion on the side of the convex portion and on a side of the inclined surface of the concave portion is a convex curved surface that forms the curved surface.
